(19) United States
(12) Patent Application Publication
(10) Pub. No.: US 2004/0252223 A1
(43) Pub. Date: Dec. 16, 2004

(54) Image pickup device, image pickup system and image pickup method

(75) Inventors: Takashi Masuno, Hirakata-shi (JP); Tatsuro Juri, Osaka-shi (JP); Kazuo Okamoto, Hirakata-shi (JP); Takashi Akiyama, Takatsuki-shi (JP)

Correspondence Address: MERCHANT & GOULD PC, P.O. BOX 2903, MINNEAPOLIS, MN, 55402-0903, US

(73) Assignee: Matsushita Electric Industrial Co., Ltd., Kadoma-shi (JP)

(21) Appl. No.: 10/861,725

(22) Filed: Jun. 4, 2004

(30) Foreign Application Priority Data
Jun. 10, 2003 (JP) 2003-165486

(51) Int. Cl. H04N 5/232

(52) U.S. Cl. 348/345

(57) ABSTRACT

An image pickup device includes: an image pickup unit that converts an image projected by an optical system into image data and outputs the image data; a storage unit that stores the image data output from the image pickup unit; a detection unit that detects an emission position of a light beam emitted from an external device from the image data stored in the storage unit; and a focus control unit that sets a focus detection area based on the emission position of the light beam and makes a focus adjustment mechanism adjust a focus of the optical system so as to maximize a high frequency component in the focus detection area.

### BACKGROUND OF THE INVENTION

1. Field of the Invention

The present invention relates to a digital image pickup device and a digital image pickup method.

2. Related Background Art

Conventionally, in the field of still cameras and video cameras, cameras equipped with an Auto Focus (AF) function by which a camera itself performs focus adjustment in lieu of a photographer and an Auto Exposes (AE) function by which a camera itself adjusts exposure are widely known. Such cameras are disclosed in, for example, JP S64(1989)-17034 A and JP H05(1993)-93844 A. Additionally, in recent years, digital still cameras and digital video cameras using image pickup elements such as CCDs and CMOSs are widely used.

In the cameras equipped with the AF function, the adjustment of focus is carried out by, in the case of a digital camera, extracting an image signal of an object residing in an area whose focal point is to be detected (hereinafter called “focus detection area”) and moving a part of a group of lenses or the whole group so that a high frequency component becomes predominant in the extracted image signal. The focus detection area is one area or a plurality of areas that are present in a finder of the camera, and a position of the area(s) normally is fixed.

When taking a photograph using the camera equipped with the AF function, a photographer adjusts a position of the camera and a subject to be photographed while observing through a finder of the camera so that the subject is within the focus detection area and simply presses a shutter button or a recording button, whereby a photograph or an image whose focusing has been adjusted properly can be obtained.

Meanwhile, in the camera equipped with the AE function, the adjustment of exposure is carried out by, in the case of a digital camera, measuring a brightness of a subject to be photographed using an image pickup element and setting a f-number and a shutter speed appropriately based on the measurement value. The f-number and the shutter speed may be set with reference to an average value of the brightness of the entire photographing area in some cases and may be set with reference to a measurement value in a photometry area that is preset in a finder in other cases.

In normal photographing, the adjustment of exposure is carried out generally by the former method. However, in the case where photographing is carried out in a state with a large difference between a brightness of the subject to be photographed and the ambient brightness or where the photographing is carried out with back light, the adjustment of exposure is carried out by the latter method. In the case of the former method being used, a photographer can obtain photographs and images whose exposure has been adjusted appropriately by pointing a lens at the subject and simply pressing a shutter button or a recording button. In the case of the latter method used, a photographer has to take a photograph by positioning a subject serving as a reference of the exposure within a photometry area while observing through a finder of the camera. Herein, the photometry area normally is set so as to overlap with the focus detection area.

Furthermore, there is a camera equipped with the AF function and the AE function, which further is equipped with a function that allows a photographer to take a photograph by remote control using a remote controller separately provided from a main body. The above-stated JP S64(1989)-17034 A and JP H05(1993)-93844 A disclose such cameras also. Such a camera enabling the photographing by remote control allows a photographer easily to take a photograph of himself/herself, and a photograph and an image obtained through this photographing can have appropriately adjusted focal points and exposure.

However, in the case where a photographer takes a photograph of himself/herself using the conventional camera equipped with the AF function, it is impossible for the photographer to confirm a positional relationship between the subject to be photographed and a focus detection area through a finder. Therefore, it becomes difficult to focus on the photographer as the subject precisely, which means it is difficult to obtain a photograph whose focus has been adjusted on the photographer as the subject.

The photographing of a photographer himself/herself as a subject will be explained below, with reference to FIG. 20, which shows an example using a still camera equipped with the AF function. FIG. 20 shows a state where the photographer takes a photograph of himself/herself as the subject using the conventional camera, where FIG. 20A shows a positional relationship between the subject and the camera and FIG. 20B shows an image seen in the finder of the image pickup device.

As shown in FIGS. 20A and 20B, in a state where the photographer 82 as the subject stands in front of the camera 81, an infrared signal is transmitted from a remote control device 83 to a photoreceptor 86 of the camera 81 so as to issue an instruction for the photographing to the camera 81. When receiving the infrared signal, the camera 81 carries out the focus adjustment and the exposure adjustment and takes a photograph.

In this example, however, the photographer 82 is within a photographing area 85, but not within a focus detection area 84. Therefore, if an object is present behind the photographer 82 and this object is within the focus detection area 84, then the camera conducts the focus adjustment for this object, so that the photographer fails to take a photograph with a focus on himself/herself.

It might be considered that the above-stated problem would be solved by the photographer 82 adjusting the focus manually with respect to his/her standing position that can be expected or carrying out focus-lock with respect to another person as another subject who stands parallel with the photographer 82. However, such operations are complicated, and in the case of an unskilled photographer, the adjustment of focus would be insufficient.

Also, in the case where the photographer takes a photograph of himself/herself as the subject as stated above, it is impossible for the photographer to confirm a positional relationship between the subject and a photometry area. Therefore, in such a case, the conventional camera equipped with the AE function carries out the adjustment of exposure with reference to an average value of the brightness in the entire photographing area.

However, the photographer in some cases may wish to adjust the exposure with reference to the brightness of himself/herself as the subject even in the case of taking his/her own photograph. Thus, in order that a photographer may take his/her own photograph, there is a demand for a camera that allows the exposure adjustment with reference to the brightness of the photographer himself/herself, irrespective of the photographer's (as the subject) position in the photographing area.

### SUMMARY OF THE INVENTION

Therefore, with the foregoing in mind, it is an object of the present invention to provide an image pickup device and an image pickup method by which a favorable image can be obtained when a photographer takes a photograph of himself/herself as a subject.

A first image pickup device of the present invention includes: an image pickup unit that converts an image projected by an optical system into image data and outputs the image data; a storage unit that stores the image data output from the image pickup unit; a detection unit that detects an emission position of a signal emitted from an external device from the image data stored in the storage unit; and a focus control unit that sets an area as a target of focus adjustment based on the detected emission position of the signal and adjusts a focus of the optical system so as to maximize a frequency component within a preset frequency band of image data of the area as the target of the focus adjustment.

A second image pickup device of the present invention includes: an image pickup unit that converts an image projected by an optical system into image data and outputs the image data; a storage unit that stores the image data output from the image pickup unit; a detection unit that detects an emission position of a signal emitted from an external device from the image data stored in the storage unit; and an exposure control unit that sets an area as a target of exposure adjustment based on the detected emission position of the signal and conducts the exposure adjustment with reference to brightness of the area as the target of the exposure adjustment.

A third image pickup device of the present invention includes: a remote control device that is configured to be capable of emitting a signal; an image pickup unit that converts an image projected by an optical system into image data and outputs the image data; a storage unit that stores the image data output from the image pickup unit; a detection unit that detects an emission position of the signal emitted from the remote control device from the image data stored in the storage unit; and a focus control unit that sets an area as a target of focus adjustment based on the detected emission position of the signal and adjusts a focus of the optical system so as to maximize a frequency component within a preset frequency band of image data of the area as the target of the focus adjustment.

A fourth image pickup device of the present invention includes: a remote control device that is configured to be capable of emitting a signal; an image pickup unit that converts an image projected by an optical system into image data and outputs the image data; a storage unit that stores the image data output from the image pickup unit; a detection unit that detects an emission position of the signal emitted from the remote control device from the image data stored in the storage unit; and an exposure control unit that sets an area as a target of exposure adjustment based on the detected emission position of the signal and conducts the exposure adjustment with reference to brightness of the area as the target of the exposure adjustment.

A first image pickup method of the present invention, which uses an image pickup element that converts an image projected by an optical system into image data, includes the steps of: (a) outputting the image data converted by the image pickup element; (b) storing the output image data into a storage device; (c) detecting an emission position of a signal emitted from an external device from the image data stored in the storage device; and (d) setting an area as a target of focus adjustment based on the detected emission position of the signal and adjusting a focus of the optical system so as to maximize a frequency component within a preset frequency band of image data of the area as the target of the focus adjustment.

A second image pickup method of the present invention, which uses an image pickup element that converts an image projected by an optical system into image data, includes the steps of: (a) outputting the image data converted by the image pickup element; (b) storing the output image data into a storage device; (c) detecting an emission position of a signal emitted from an external device from the image data stored in the storage device; and (d) setting an area as a target of exposure adjustment based on the detected emission position of the signal and conducting the exposure adjustment with reference to brightness of the area as the target of the exposure adjustment.

Furthermore, the present invention may be a computer program product that includes a program recorded in a recording medium, the program being for embodying the above-stated image pickup methods of the present invention with a computer. By installing this program into a computer and executing the same, the image pickup method according to the present invention can be executed.

### BRIEF DESCRIPTION OF THE DRAWINGS

FIG. 1 shows a state where a photographer takes a photograph of himself/herself as a subject using the image pickup device according to Embodiment 1 of the present invention, where FIG. 1A shows a positional relationship between the subject and the camera and FIG. 1B shows an image seen in a finder of the image pickup device.

FIG. 2 shows a main configuration of the image pickup device according to Embodiment 1 of the present invention.

FIG. 3 is a flowchart showing the image pickup method and the operations of the image pickup device according to Embodiment 1 of the present invention.

FIG. 4 shows the image pickup procedure specifically, where FIG. 4A is a flowchart showing major steps in the image pickup procedure and FIG. 4B shows a memory map in the storage unit.

FIG. 5 is a flowchart showing major steps of the detection procedure.

FIG. 6 shows the configuration of the focus control unit shown in FIG. 2 more specifically.

FIG. 7 is a flowchart showing major steps of the focus adjustment procedure.

FIG. 8 shows an image seen in a finder of the image pickup device when a photographer takes his/her own photograph using the image pickup device according to Embodiment 2 of the present invention.

FIG. 9 shows a main configuration of the image pickup device according to Embodiment 2 of the present invention.

FIG. 10 is a flowchart showing the image pickup method and the operations of the image pickup device according to Embodiment 2 of the present invention.

FIG. 11 shows a main configuration of the image pickup device according to Embodiment 3 of the present invention.

FIG. 12 shows a configuration of a white balance adjustment unit shown in FIG. 11 more specifically.

FIG. 13 is a flowchart showing the image pickup method and the operations of the image pickup device according to Embodiment 3 of the present invention.

FIG. 14 is a flowchart showing major steps of an image adjustment procedure.

FIG. 15 shows an image seen in a finder of the image pickup device when a photographer takes his/her own photograph using the image pickup device according to Embodiment 4 of the present invention.

FIG. 16 shows a main configuration of the image pickup device according to Embodiment 4 of the present invention.

FIG. 17 shows a specific configuration of an exposure control unit shown in FIG. 16.

FIG. 18 is a flowchart showing the image pickup method and the operations of the image pickup device according to Embodiment 4 of the present invention.

FIG. 19 shows the exposure adjustment procedure, where FIG. 19A is a flowchart showing the major steps of the exposure adjustment procedure, and FIG. 19B shows an exposure setting table used in the exposure adjustment procedure.

FIG. 20 shows a state where a photographer takes a photograph of himself/herself as a subject using the conventional camera, where FIG. 20A shows a positional relationship between the subject and the camera and FIG. 20B shows an image seen in the finder of the image pickup device.

### DETAILED DESCRIPTION OF THE INVENTION

According to the above-stated first image pickup device, an area as a target of focus adjustment is set with reference to the emission position of the signal emitted from the external device and the focus adjustment is conducted with respect to this area. Therefore, when a photographer takes a photograph of himself/herself as a subject, the photographer can obtain a photograph and an image whose focus has been adjusted appropriately simply by staying in a photographing area and making the external device emit a signal.

In the above-stated first image pickup device, preferably, the external device is configured to be capable of emitting a light beam in a preset pattern as the signal. The image pickup unit includes an image pickup element that converts an image projected by the optical system into image data at a preset time intervals. Each piece of the image data converted by the image pickup element is output sequentially per each frame to the storage unit. The storage unit stores therein each piece of image data output from the image pickup unit in the output order, and the detection unit makes a comparison among the respective pieces of image data stored in the storage unit so as to detect a pixel or a group of pixels that are changed in the preset pattern and regards a position of the detected pixel or group of pixels as the emission position.

Furthermore, the above-stated first image pickup device further may include an exposure control unit that sets an area as an object of exposure adjustment based on the emission position of the signal, and conducts the exposure adjustment with reference to brightness of the area as the target of the exposure adjustment. In this embodiment, it is preferable that the optical system includes an aperture whose f-number is variable, and the image pickup unit includes an electronic shutter whose shutter speed is variable, and the exposure control unit calculates an average brightness value of the area as the target of the exposure adjustment, and adjusts at least one of the f-number and the shutter speed based on the calculated average brightness value. Alternatively, it is preferable that the optical system includes an aperture whose f-number is variable and a shutter mechanism whose shutter speed is variable, and the exposure control unit calculates an average brightness value of the area as the target of the exposure adjustment, and adjusts at least one of the f-number and the shutter speed based on the calculated average brightness value.

According to the above-stated second image pickup device, an area as a target of exposure adjustment is set with reference to the emission position of the signal emitted from the external device and the exposure adjustment is conducted with respect to this area. Therefore, when a photographer takes a photograph of himself/herself as a subject, the photographer can obtain a photograph and an image whose focus has been adjusted appropriately simply by staying in a photographing area and making the external device emit a signal.

In the above-stated second image pickup device, preferably, the external device is configured to be capable of emitting a light beam in a preset pattern as the signal. The image pickup unit includes an image pickup element that converts an image projected by the optical system into image data at a preset time intervals. Each piece of the image data converted by the image pickup element is output sequentially per each frame to the storage unit. The storage unit stores therein each piece of image data output from the image pickup unit in the output order, and the detection unit makes a comparison among the respective pieces of image data stored in the storage unit so as to detect a pixel or a group of pixels that are changed in the preset pattern and regards the detected pixel or group of pixels as the emission position.

Furthermore, in the above-stated second image pickup device, it is preferable that the optical system includes an aperture whose f-number is variable, and the image pickup unit includes an electronic shutter whose shutter speed is variable, and the exposure control unit calculates an average brightness value of the area as the target of the exposure adjustment, and adjusts at least one of the f-number and the shutter speed based on the calculated average brightness value. Alternatively, it is preferable that the optical system includes an aperture whose f-number is variable and a shutter mechanism whose shutter speed is variable, and the exposure control unit calculates an average brightness value of the area as the target of the exposure adjustment, and adjusts at least one of the f-number and the shutter speed based on the calculated average brightness value.

Furthermore, the above-stated first image pickup device and second image pickup device further may include a trimming unit that cuts an image displayed in accordance with the image data stored in the storage unit to be in a preset size, wherein the trimming unit conducts the cutting so that the emission position of the signal detected by the detection unit is located at the center of the cut image or becomes the closest to the center of the cut image. In this embodiment, the image pickup unit may include an image pickup element, and the image pickup device further may include a moving mechanism that moves both of the optical system and the image pickup element in a direction perpendicular to an optical axis of the optical system, and the focus control unit may make the moving mechanism move both of the optical system and the image pickup element so that the emission position of the signal detected by the detection unit is located at the center of the cut image or becomes the closest to the center of the cut image.

Moreover, in the above-stated first image pickup device and second image pickup device, it is preferable that the external device is a remote control device for conducting remote control of the image pickup device. Furthermore, it is preferable that the remote control device includes a case provided with a portion in a preset reference color, and the image pickup device includes a white balance adjustment unit that conducts adjustment of white balance with reference to the reference color. Furthermore, it is preferable that the white balance adjustment unit includes: a reference area extraction unit that extracts image data of an area including the portion in the reference color from the image data stored in the storage unit; a gain adjustment value calculation unit that calculates a gain adjustment value based on the extracted image data of the area including the portion in the reference color, the gain adjustment value being for making a RGB ratio of an average color of the area including the portion in the reference color a preset ratio; a color separation unit that separates the image data stored in the storage unit into a R component, a G component and a B component; and a gain adjustment unit that conducts gain adjustment of at least one of the R component, the G component and the B component using the calculated gain adjustment value.

According to the above-stated first image pickup method, an area as a target of focus adjustment is set with reference to the emission position of the signal emitted from the external device and the focus adjustment is conducted with respect to this area. Therefore, when a photographer takes a photograph of himself/herself as a subject, the photographer can obtain a photograph and an image whose focus has been adjusted appropriately simply by staying in a photographing area and making the external device emit a signal.

Preferably, the above-stated first image pickup method further includes the step of setting an area as an object of exposure adjustment based on the detected emission position of the signal, and conducting the exposure adjustment with reference to brightness of the area as the target of the exposure adjustment.

According to the above-stated second image pickup method, an area as a target of exposure adjustment is set with reference to the emission position of the signal emitted from the external device and the exposure adjustment is conducted with respect to this area. Therefore, when a photographer takes a photograph of himself/herself as a subject, the photographer can obtain a photograph and an image whose focus has been adjusted appropriately simply by staying in a photographing area and making the external device emit a signal.

In the above-stated first and second image pickup methods, preferably, the external device emits a light beam as the signal. Preferably, the above-stated first image pickup method and second image pickup method further include the step of: cutting an image displayed in accordance with the image data stored in the storage unit to be in a preset size. The cutting is conducted so that the emission position of the signal detected in the step (c) is located at the center of the cut image or becomes the closest to the center of the cut image.

Furthermore, in the above-stated first image pickup method and second image pickup method, it is preferable that the external device includes a case provided with a portion in a preset reference color, and the image pickup method further includes the step of conducting adjustment of white balance with reference to the reference color. In this embodiment, it is preferable that the step of conducting the adjustment of white balance includes the steps of extracting image data of an area including the portion in the reference color from the image data stored in the storage unit; calculating a gain adjustment value based on the extracted image data of the area including the portion in the reference color, the gain adjustment value being for making a RGB ratio of an average color of the area including the portion in the reference color a preset ratio; separating the image data stored in the storage unit into a R component, a G component and a B component; and conducting gain adjustment of at least one of the R component, the G component and the B component using the calculated gain adjustment value.

Embodiment 1

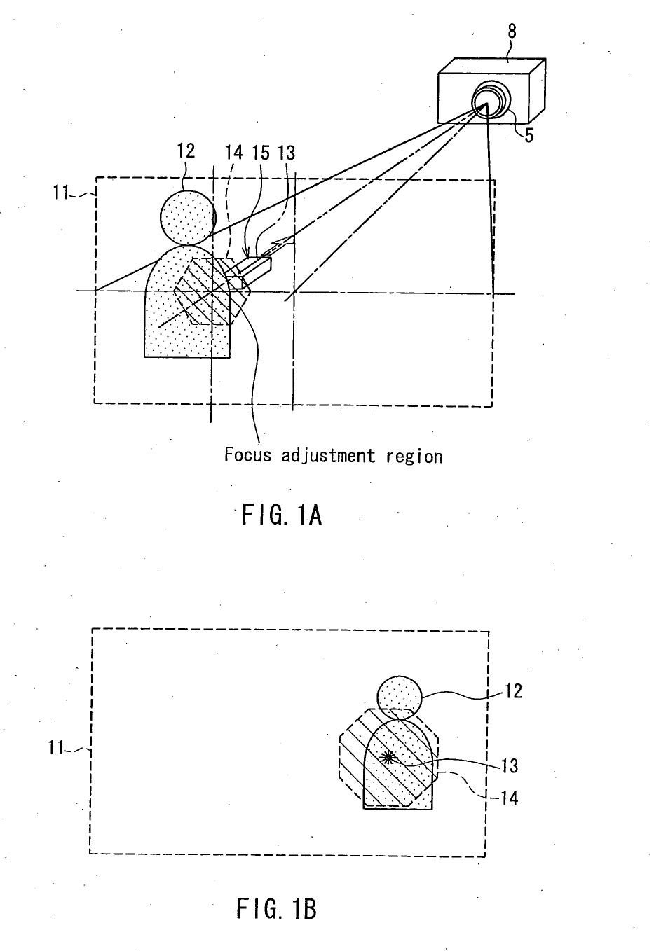

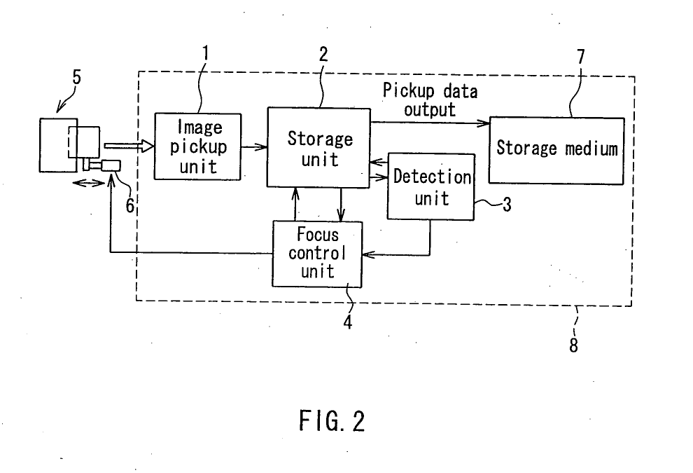

The following describes an image pickup device and an image pickup method according to Embodiment 1 of the present invention, with reference to FIGS. 1 to 7. Firstly, a configuration of the image pickup device according to Embodiment 1 will be described below, with reference to FIGS. 1 and 2. The image pickup device according to Embodiment 1 is a digital still camera.

FIG. 1 shows a state where a photographer takes a photograph of himself/herself as a subject using the image pickup device according to Embodiment 1 of the present invention. FIG. 1A shows a positional relationship between the subject and the camera and FIG. 1B shows an image seen in a finder of the image pickup device. FIG. 2 shows a main configuration of the image pickup device according to Embodiment 1 of the present invention.

As shown in FIG. 1A, an optical system 5 is attached to an image pickup device 8 according to Embodiment 1. Furthermore, the image pickup device 8 can take a photograph in response to a signal transmitted by radio from a remote control device 15 as an external device. Therefore, the photographer can take a photograph of himself/herself as a subject 12 by staying in a photographing area 11 and operating the remote control device 15 in the similar manner to the case using the conventional camera, which has been shown as the prior art.

In Embodiment 1, however, the image pickup device 8 can detect, as shown in FIG. 1B, a position of a luminous point 13 of a light beam (i.e., emission position of the light beam) that is emitted from the remote control device 15 in a predetermined pattern. The image pickup device 8 further can set an area 14 that becomes a target for the focus adjustment (focus detection area) based on the detected emission position of the light beam so as to enable the focus adjustment with respect to the thus set focus detection area 14. The image pickup device 8 is different in this respect from the conventional camera whose focus detection area is fixed. This aspect will be explained below in detail, with reference to FIG. 2.

As shown in FIG. 2, the image pickup device 8 according to Embodiment 1 includes an image pickup unit 1, a storage unit 2, a detection unit 3 and a focus control unit 4, which are put in a main body of the camera (See FIG. 2). The main body of the camera further includes the optical system 5 attached thereto, and the optical system 5 includes a focus adjustment mechanism 6 that carries out the focus adjustment for the optical system 5. The image pickup device 8 further is equipped with a storage medium 7 that records pickup data, and the storage medium 7 may be removable.

The image pickup unit 1 includes an image pickup element (not illustrated) such as a CCD or a CMOS, by which an image projected by the optical system 5 is converted into image data. The conversion into the image data by the image pickup element is carried out repeatedly at preset intervals (e.g., 1/60 second and 1/30 second).

Furthermore, in Embodiment 1, the image pickup unit 1 allows the image pickup element to operate as an electronic shutter. For instance, in the case where the image pickup element is a CCD, the image pickup unit 1 adds a discharging pulse for making an accumulated electrical charge zero in addition to a field shift pulse so as to allow the image pickup element to operate as the electronic shutter. Moreover, in this case, by altering a timing to add the discharging pulse, the image pickup unit 1 can change a shutter speed.

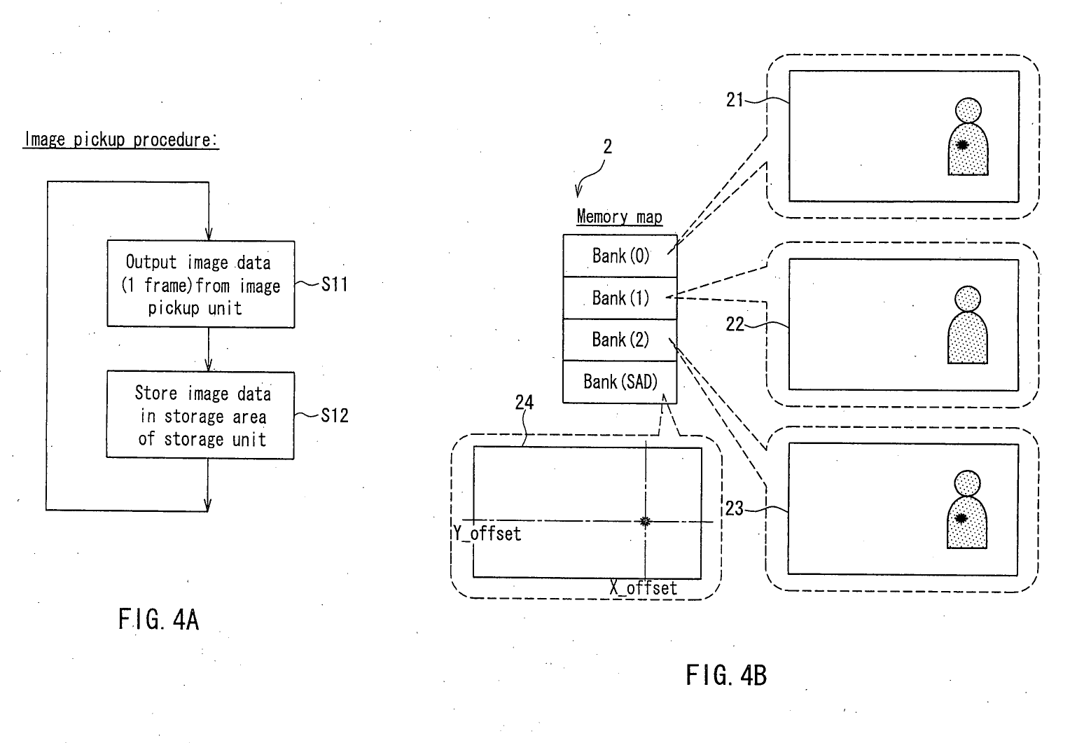

The image pickup unit 1 outputs the image data converted by the image pickup element to the storage unit 2 sequentially per each frame. The storage unit 2 stores the image data per each frame in the order output from the image pickup unit 1 (See FIG. 4B, which will be described later).

From the image data stored in the storage unit 2, the detection unit 3 detects the emission position (position of the luminous point 13: See FIG. 1) of the light beam emitted from the remote control device 15 (See FIG. 1). The light beam referred to herein that is emitted from the remote control device 15 is for detecting the focus detection area 14. In Embodiment 1, this light beam is emitted in a preset pattern. The preset pattern available includes a pattern in which turning-ON and OFF of the light are repeated in accordance with a time interval to convert an optical image into image data by the image pickup element, and in this case, the storage unit 2 stores image data in the light-up state and image data in the light-out state alternately (See FIG. 4B, which will be described later).

Furthermore, in Embodiment 1, the detection of the emission position by the detection unit 3 is carried out by reading out each piece of image data stored in the storage unit 2 and making a comparison among the read-out image data. For instance, in the case where the light is emitted from the remote control device in the pattern of light-on and light-out states repeatedly conducted as stated above, the detection unit 3 makes a comparison between the image data in the light-out state and the image data in the light-on state so as to detect a position of a pixel or a group of pixels that is changed with the passage of time.

Moreover, the detection unit 3 regards the thus detected pixel or group of pixels as an emission position of the light beam. Additionally, the detection unit 3 makes the storage unit 2 store positional information for specifying this emission position and outputs the same to the focus control unit 4.

The focus control unit 4 sets a focus detection area 14 (See FIG. 1) based on the emission position specified by the positional information output from the detection unit 3. In Embodiment 1, as shown in FIG. 1, the focus control unit 4 sets the emission position of the light beam (coordinates of the luminous point 13) at a center of the focus detection area 14. It should be noted that the present invention is not limited to this, as long as the focus detection area 14 is set with reference to the emission position of the light beam.

In the present invention, the focus detection area 14 may be set within a range smaller than the photographing area of the image pickup device 8. The size of the focus detection area 14 can be set suitably depending on a distance between the subject in the focus detection area 14 and the image pickup device 8. For instance, one possible embodiment is such that the focus detection area 14 is expanded with increasing proximity between the subject in the focus detection area 14 and the image pickup device 8.

Furthermore, the focus control unit 4 conducts the focus adjustment of the optical system 5 so as to maximize a high frequency component in the image data of the focus detection area 14. More specifically, the focus control unit 4 drives the focus adjustment mechanism 6 so as to move a part of or the whole lens group constituting the optical system 5 to and fro along an optical axis while reading out the image data in the focus detection area 14 from the storage unit 2 and calculating a high frequency component contained in the read out image data so as to keep a position of the lens group where the high frequency component becomes the maximum.

Note here that, in the following description, the position of the lens group that moves during the focus adjustment will be referred to as a “lens position”. The high frequency component referred to herein is a frequency component obtained by converting image data at a contour portion of the image stored as image data per each frame into frequency domain.

On completion of the focus adjustment by the focus control unit 4, the image data that has been output from the image pickup unit 1 at that point in time is output as pickup data from the storage unit 2 to the storage medium 7 so as to be stored in the storage medium 7.

The focus adjustment mechanism 6 provided in the optical system 5 conducts the focus adjustment by moving a part of or the whole lens group constituting the optical system 5 to and fro along an optical axis, which is conducted in response to a lens position driving signal output from the focus control unit 4. In Embodiment 1, the focus adjustment mechanism 6 includes a servo motor, a ball screw and the like, but the present invention is not limited to this.

The focus adjustment mechanism 6 may be an ultrasonic motor, for example, that is capable of moving a lens without the help of a ball screw and the like. Furthermore, in an image pickup device that includes an optical system 5 removable from a main body of a camera, the focus adjustment mechanism 6 may be mounted on the main body of the camera or may be mounted on the optical system 5.

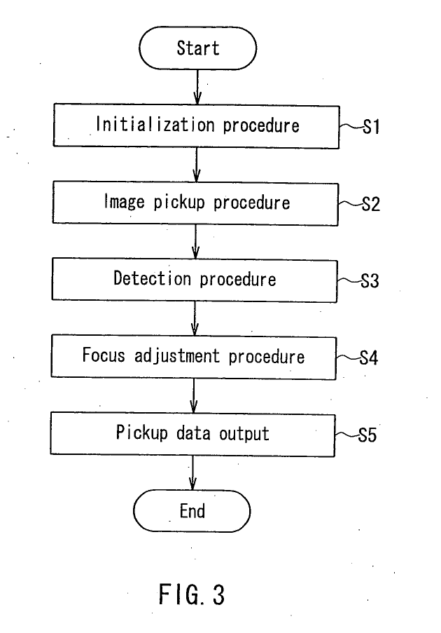

The following describes an image pickup method and operations of the image pickup device according to Embodiment 1, with reference to FIGS. 3 to 7. Note here that the image pickup method according to Embodiment 1 is implemented by operating the image pickup device according to Embodiment 1 shown in FIGS. 1 and 2. Thus, the image pickup method according to Embodiment 1 will be explained by explaining the operations of the image pickup device according to Embodiment 1.

FIG. 3 is a flowchart showing the image pickup method and the operations of the image pickup device according to Embodiment 1 of the present invention. FIG. 3 shows general steps only and details of each step will be explained with reference to FIGS. 4 to 7.

As shown in FIG. 3, firstly, the focus control unit 4 sets initial values of various parameters (initialization procedure; Step S1). Subsequently, the image pickup unit 1 outputs the image data converted by the image pickup element to the storage unit 2 and the storage unit 2 stores the output image data (image pickup procedure; Step S2). Then, the detection unit 3 detects from the image data stored in the storage unit 2 the emission position of the light beam emitted from the remote control device (detection procedure; Step S3). Next, the focus control unit 4 carries out the focus adjustment so as to maximize the high frequency component of the image data in the focus detection area (focus adjustment procedure; Step S4). Thereafter, the storage unit 2 outputs the pickup data to the storage medium 7 (Step S5) so as to complete the photographing.

Note here that the various parameters for which initial values are to be set include: central coordinates (X_offset, Y_offset) of the focus detection area 14 (See FIG. 1); a number n of the storage area (Bank: See FIG. 4B) of the storage unit 2 in which the latest image data output from the image pickup unit 1 is stored; a number m of the storage area (Bank: See FIG. 4B) in the storage unit 2 that the detection unit 3 accesses so as to read out image data as a target of the comparison; the number of frames used in the detection procedure (Sad_loop_max); a position of the optical system; focus evaluation values used in the focus adjustment procedure and the like.

The image pickup procedure (Step S2), the detection procedure (Step S3) and the focus adjustment procedure (Step S4) will be explained below more specifically. The image pickup procedure (Step S2) will be explained first. FIG. 4 shows the image pickup procedure more specifically, where FIG. 4A is a flowchart showing general steps of the image pickup procedure and FIG. 4B shows a memory map in the storage unit.

As shown in FIG. 4A, the image pickup procedure begins with the outputting of image data per each frame from the image pickup unit 1 (Step S11). Subsequently, the output image data is stored in the storage area of the storage unit 2 (Step S12). On completion of Step S12, Step S11 is conducted again, and Step S11 and Step S12 are conducted repeatedly.

Furthermore, as shown in FIG. 4B, in Embodiment 1, the storage unit 2 is provided with three storage areas (Bank (0) to Bank (2)) in which image data for each frame is stored, whereby three pieces of image data 21 to 23 can be stored at one time. Note here that the number of the storage areas in the present invention is not particularly limited.

In Embodiment 1, the latest image output from the image pickup unit 1 is stored in Bank(n). Herein, n has an initial value of “0” and the maximum value (n_max) of “2”, which are set in the initialization procedure, where n is changed as in 0, 1, 2, 0, 1, 2 . . . . Therefore, in the example of FIG. 4B, the image data 23 stored in Bank(2) is the latest image data, and the image data 21 stored in Bank(0) is the oldest image data.

Furthermore, if the latest image data is output in the state where image data has been stored in all of the storage areas, the storage area in which the oldest image data has been stored is overwritten with this latest image data. In the case of the example of FIG. 4B, when new image data is output after the output of the image data 23, then the image data 21 in Bank(0) is overwritten with the latest image data.

Note here that Bank(SAD) is a storage area used in the detection procedure, which will be described later. In this area also, image data 24 is stored in the unit of frames. It should be noted that, in the image data stored in Bank(SAD), the value indicated by each pixel is a value obtained by summing absolute values equal to a difference obtained from the comparison between two pieces of image data (absolute difference) as described later. Bank(SAD) further stores information for specifying the central coordinates (X_offset, Y_offset) of the focus detection area 14 (See FIG. 1).

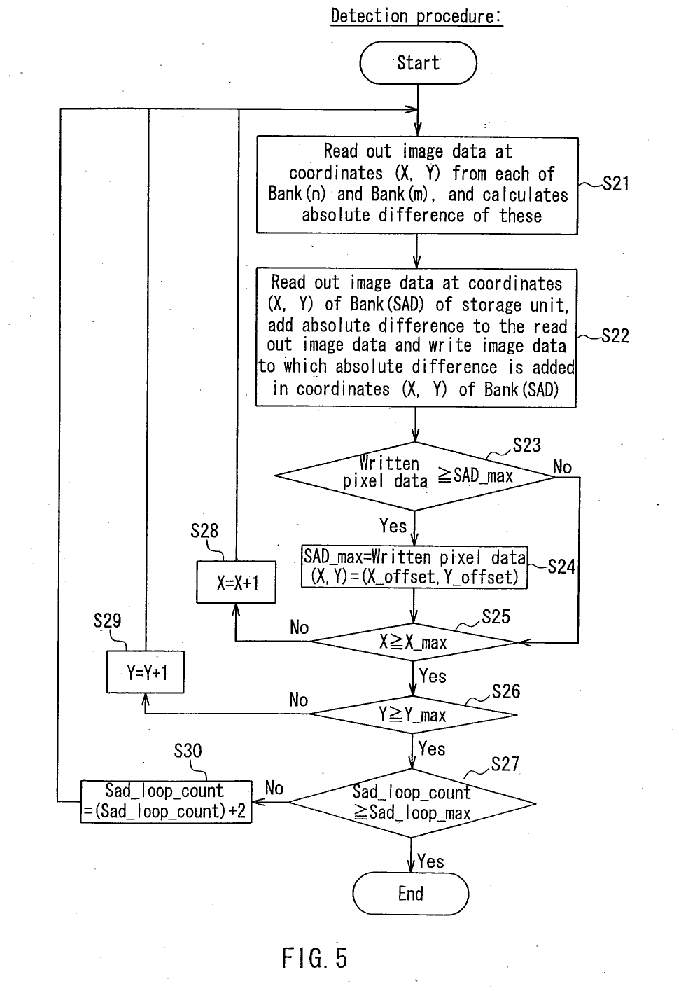

Next, the detection procedure (Step S3) will be described. FIG. 5 is a flowchart showing major steps of the detection procedure. In FIG. 5, as described above, Bank(n) shows the storage area in which the latest image data is stored and Bank(m) shows the storage area in which image data has been stored before the latest image data is stored in Bank(n). The image stored in Bank(m) serves as the target of the comparison in the detection procedure. That is to say, as described above, “m” denotes the number of the Bank that the detection unit 3 accesses so as to read out the image data as the target of the comparison.

Furthermore, in FIG. 5, the coordinates (X, Y) are coordinates of a pixel constituting the image data, and the coordinates (X, Y) are set at the origin point in the initial procedure. The origin point is an upper left corner of the image (See FIG. 1 and FIG. 4B). Moreover, an X axis is set along the horizontal direction of the image, and a Y axis is set along the vertical direction of the same. Furthermore, “X_max” corresponds to the number of pixels in the horizontal direction of the image pickup element, and “Y_max” corresponds to the number of pixels in the vertical direction of the image pickup element.

“SAD_MAX” shown in FIG. 5 indicates the maximum value of values obtained by summing the above-stated absolute difference, which is set at “0” in the initialization procedure. “Sad_loop_max” indicates the number of frames used in the detection procedure as stated above, which is set at “8” in the initialization procedure. “Sad_loop_count” indicates the total sum of the number of frames used during the execution of the detection procedure, which is set at “0” in the initialization procedure.

As shown in FIG. 5, the detection unit 3 firstly reads out the image data at the coordinates (X, Y) from each of Bank(n) and Bank(m) and calculates the absolute difference of them (Step S21).

Next, the detection unit 3 reads out the image data of the coordinates (X, Y) in Bank(SAD), adds the absolute difference calculated at Step S21 to the read out image data and writes the image data with the absolute difference added thereto in the coordinates (X, Y) in Bank(SAD) (Step S22).

In this way, the difference of pixel at the coordinates (X, Y) between Bank(n) in which the latest image is stored and Bank(m) in which the immediately preceding image is stored is added in the coordinates (X, Y) of Bank(SAD) as an estimation value concerning the amount and the frequency of a change in pixel.

Subsequently, the detection unit 3 compares the value of the image data written at Step S22 and the value of “SAD_MAX” (Step S23). If the value of the written image data is equal to or larger than the value of “SAD_MAX”, the value of “SAD_MAX” is replaced with the value of the written image data, and further the coordinates that are stored as (X_offset, Y_offset) in Bank(SAD) are replaced with the coordinates (X, Y) and the coordinates (X, Y) are set as (X_offset, Y_offset) (Step S24). Thereafter, the detection unit 3 executes Step S25. On the other hand, if the value of the written image data is smaller than the value of “SAD_MAX”, Step S24 is not executed and the detection unit 3 executes Step S25.

At Step S25, the detection unit 3 compares the value of X with the value of “X_max”. As a result of the comparison, if the value of X is smaller than the value of “X_max”, “1” is added to the value of X and the procedure from Step S24 is executed again. On the other hand, if the value of X is equal to or larger than the value of “X_Max”, the detection unit 3 executes Step S26.

At Step S26, the detection unit 3 compares the value of Y with the value of “Y_max”. As a result of the comparison, if the value of Y is smaller than the value of “Y_max”, “1” is added to the value of Y and the procedure from Step S21 is executed again. At this time, the detection unit 3 sets the value of X at “0”. On the other hand, if the value of Y is equal to or larger than the value of “Y_max”, the detection unit 3 executes Step S27.

At Step S27, the detection unit 3 compares the value of “Sad_loop_count” with the value of “Sad_loop_max”. As a result of the comparison, if the value of “Sad_loop_count” is smaller than the value of “Sad_loop_max”, “2” is added to the value of “Sad_loop_count”, and the procedure from Step S21 is executed again. At this time, the detection unit 3 sets both of the values of X and Y at “0”. On the other hand, if the value of “Sad_loop_count” is equal to or larger than the value of “Sad_loop_max”, the detection unit 3 completes the detection procedure.

In this way, as a result of the execution of Steps S21 through S30 by the detection unit 3, the coordinates of the luminous point 13 (See FIG. 1) (emission position of the light beam) from the remote control device 15, i.e., the coordinates of a pixel that is changed significantly with the passage of time, can be specified as (X_offset, Y_offset). The thus specified coordinates are set at central coordinates of the focus detection area 14 (See FIG. 1) and are stored in Bank(SAD) of the storage unit 2. Furthermore, after the completion of the detection procedure, the detection unit 3 reads out (X_offset, Y_offset) from Bank(SAD) of the storage unit 2 and outputs positional information for specifying these coordinates to the focus control unit 4.

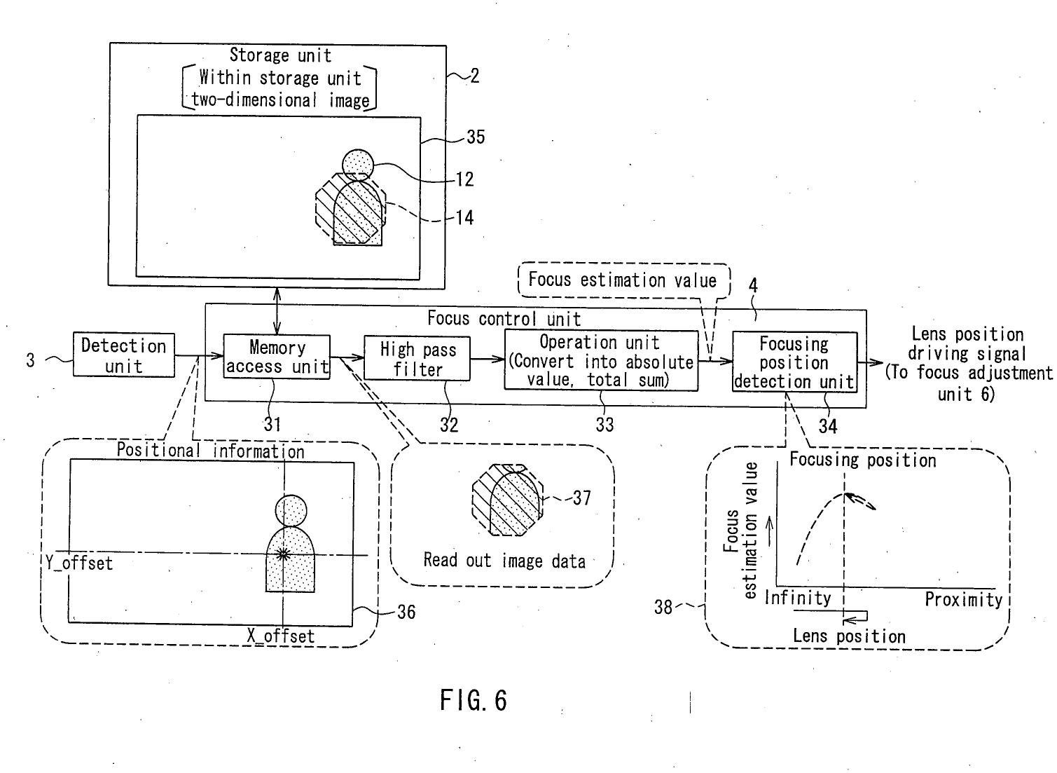

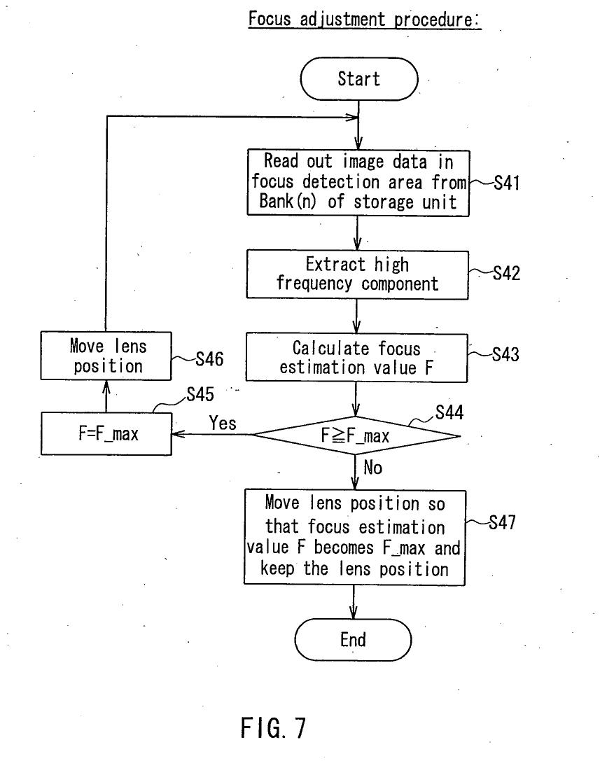

Next, the focus adjustment procedure (Step S4) will be described below. In Embodiment 1, the focus control unit 4 includes a configuration shown in FIG. 6, and this configuration enables the focus adjustment procedure. FIG. 6 shows the configuration of the focus control unit shown in FIG. 2 more specifically. FIG. 7 is a flowchart showing general steps of the focus adjustment procedure.

As shown in FIG. 6, the focus control unit 4 has a memory access unit 31, a high pass filter 32, an operation unit 33 and a focusing position detection unit 34. The memory access unit 31 receives positional information 36 for specifying the coordinates (X_offset, Y_offset) of the luminous point from the detection unit 3.

Furthermore, the memory access unit 31 accesses the storage unit 2 so as to read out image data 37 of the focus detection area 14 including the coordinates (X_offset, Y_offset) as its center from the image data 35 stored in Bank(n) of the storage unit 2.

The high pass filter 32 extracts a frequency component within a preset frequency band, i.e., a high frequency component, from the image data 37 read out by the memory access unit 31. The high pass filter 32 available includes an IIR filter, for example. The operation unit 33 converts the high frequency component extracted by the high pass filter 32 into an absolute value, and adds the thus converted high frequency component as the absolute value to a high frequency peak value in the horizontal direction and a high frequency peak value in the vertical direction, for example, so as to calculate a focus estimation value F.

While moving a part of or the whole lens group constituting the optical system to and fro along an optical axis by outputting a lens position driving signal to the focus adjustment mechanism 6 (See FIG. 2), the focusing position detection unit 34 detects a lens position that makes the focus estimation value F output from the operation unit 33 the maximum, i.e., makes the high frequency component the maximum. When the lens position that makes the focus estimation value F the maximum can be detected, the focusing position detection unit 34 makes the focus adjustment mechanism 6 hold the lens position.

In FIG. 6, graph 38 shows a relationship between the lens position and the focus estimation value F. As the lens position is moved, the focus estimation value F is plotted as a quadric curve that is convex upward. The lens position where this quadric curve becomes the maximum value is a focusing position. In the present invention, the configuration of the focus control unit 4 is not limited to that shown in FIG. 6.

The focus control procedure by the focus control unit 4 shown in FIG. 6 will be explained now, with reference to FIG. 7. Note here that, in the initialization procedure, the lens position is set on a side distant (infinity) from the focusing position and the focus estimation value F and the maximum value “F_max” of the focus estimation value both are set at “0”. If required, FIG. 6 will be referred to in the following description.

As shown in FIG. 7, when receiving the positional information 36 for specifying the coordinates (X_offset, Y_offset) from the detection unit 3, the memory access unit 31 firstly accesses the storage unit 2 to read out the image data 37 of the focus detection area 14 including the coordinates (X_offset, Y_offset) as its center from the image data 35 stored in Bank(n) of the storage unit (Step S41).

Next, the high pass filter 32 extracts a high frequency component from the image data 37, and inputs the extracted high frequency component to the operation unit 33 (Step S42). Further, the operation unit 33 converts the high frequency component extracted by the high pass filter 32 into an absolute value and sums up the converted high frequency components as the absolute values so as to calculate a focus estimation value F (Step S43).

Subsequently, the focusing position detection unit 43 makes a judgment as to whether the calculated focus estimation value F is the maximum value “F_max” or not (Step S44). In the case where the calculated focus estimation value F is “F_max” or larger, the calculated focus estimation value F is set as “F_max” (Step S45) and outputs a lens position driving signal to the focus adjustment unit 6 so as to move the lens position toward a proximity side (Step S46). Thereafter, Step S41 by the memory access unit 31, Step S42 by the high pass filter 32 and Step S43 by the operation unit 33 are executed again.

On the other hand, in the case where the calculated focus estimation value F is smaller than “F_max”, it can be considered that the lens position is located on a proximity side relative to the focusing position. Therefore, the focusing position detection unit 43 moves the lens position so that the focus estimation value F becomes “F_max”, and the lens position is held (Step S47). After the execution of Step S47, the focus control unit 4 completes the focus control procedure.

In this way, in Embodiment 1, the focus adjustment is carried out by the focus control unit 4 that performs feedback control of the lens position of the optical system 5 based on the focus estimation value F.

As stated above, according to the image pickup device and the image pickup method of Embodiment 1, the focus adjustment can be carried out by setting a surrounding area of a position where the light beam is emitted from the remote control device as the focus detection area. Thus, in the case where a photographer takes his/her own photograph, the photographer can obtain a photograph or an image whose focus has been adjusted appropriately simply by staying in the photographing area and operating the remote control device. In addition, there is no need for the photographer to carry out complicated operations such as the manual focus adjustment and focus lock as in the conventional device.

Furthermore, programs embodying Steps S1 through S5 shown in FIG. 3, Steps S11 through S14 shown in FIG. 4, Steps S21 through S30 shown in FIG. 5 and Steps S41 through S46 shown in FIG. 7 may be installed into a personal computer to which an external camera (a camera equipped with the optical system and the image pickup unit in Embodiment 1 only) is connected via USB and the like or into a computer to which a general digital camera is connected. These programs may be executed and the image pickup device according to Embodiment 1 can be realized.

In this case, a CPU (central processing unit) of the computer functions as the detection unit 3 and the focus control unit 4, and RAM memory of the computer functions as the storage unit 2 so as to carry out the image pickup procedure. Alternatively, in the case where the camera connected with the computer is equipped with the image pickup element and the optical system only and cannot function as the image pickup unit 1, a CPU may function as the image pickup unit 1.

Embodiment 2

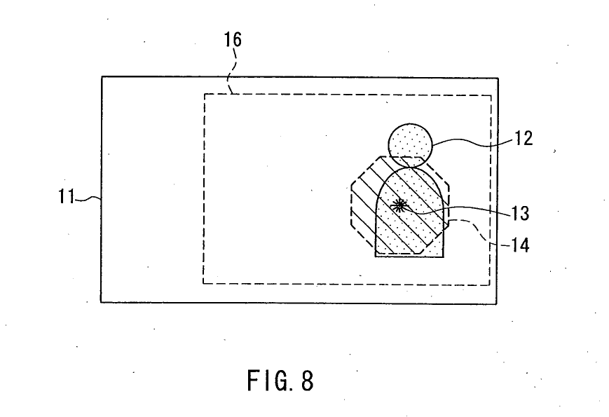

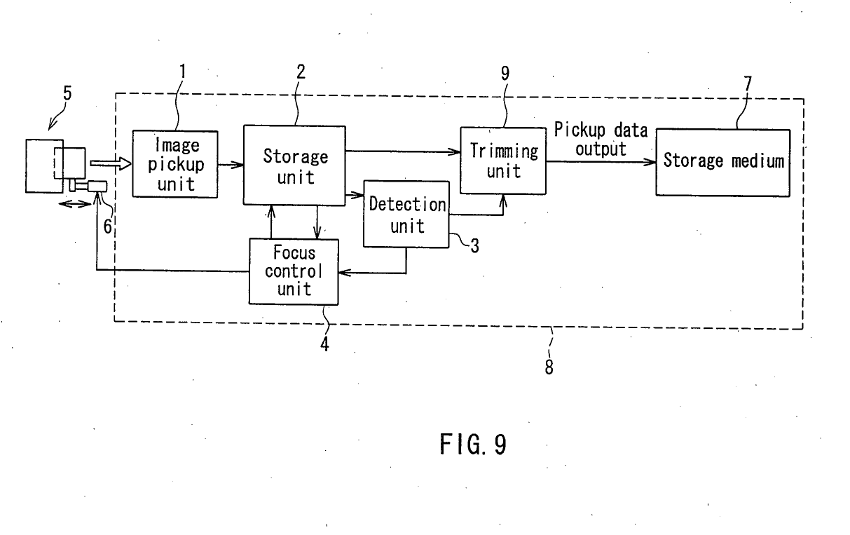

The following describes an image pickup device and an image pickup method according to Embodiment 2 of the present invention, with reference to FIGS. 8 to 10. Firstly, referring to FIGS. 8 and 9, a configuration of the image pickup device according to Embodiment 2 will be explained below. The image pickup device according to Embodiment 2 also is a digital still camera.

FIG. 8 shows an image seen in a finder of the image pickup device when a photographer takes his/her own photograph using the image pickup device according to Embodiment 2 of the present invention. FIG. 9 shows a main configuration of the image pickup device according to Embodiment 2 of the present invention.

As shown in FIG. 8, the image pickup device according to Embodiment 2 is equipped with a function of cutting a partial area (trimming area) 16 of a photographing area 11. Furthermore, the image pickup device according to Embodiment 2 is capable of outputting image data of the trimming area 16 as pickup data.

More specifically, as shown in FIG. 9, the image pickup device according to Embodiment 2 has a trimming unit 9, which is different from the image pickup device according to Embodiment 1. Except for this point, the image pickup device according to Embodiment 2 has the same configuration as that of the image pickup device according to Embodiment 1.

The trimming unit 9 has a function of cutting an image displayed in accordance with image data stored in a storage unit 2 to have a size of a preset trimming area 16. More specifically, the trimming unit 9 cuts image data output from the storage unit 2 as pickup data and outputs the cut image data to a storage medium 7.

Note here that, in Embodiment 2, the size of the trimming area 16 may be set freely by the photographer. Furthermore, a plurality of types of trimming areas 16 with different sizes may be set in the image pickup device so as to allow the photographer to choose one of them freely during the photographing.

Furthermore, in Embodiment 2, the trimming unit 9 is connected with a detection unit 3. Then, the detection unit 3 outputs coordinates (X_offset, Y_offset) to the trimming unit 9 in addition to the focus control unit 4. Therefore, the trimming unit 9 conducts cutting so that an emission position of a light beam (position of a luminous point 13) detected by the detection unit 3 is located at the center of the cut image (trimming area 16) or becomes the closest to the center of the cut image (trimming area 16).

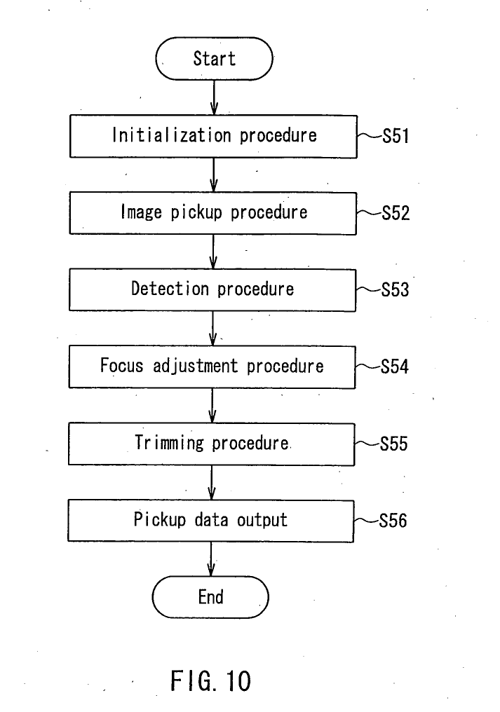

The following describes an image pickup method and operations of the image pickup device according to Embodiment 2, with reference to FIG. 10. Similarly to Embodiment 1, the image pickup method according to Embodiment 2 is implemented by operating the image pickup device according to Embodiment 2. Thus, the image pickup method according to Embodiment 2 will be explained by explaining the operations of the image pickup device according to Embodiment 2.

FIG. 10 is a flowchart showing the image pickup method and the operations of the image pickup device according to Embodiment 2 of the present invention. FIG. 10 shows general steps only.

As shown in FIG. 10, in Embodiment 2 also, an initialization procedure is conducted firstly (Step S51) like Embodiment 1. Subsequently, an image pickup procedure by the image pickup unit 1 and the storage unit 2 (Step S52); a detection procedure by the detection unit 3 (Step S53) and a focus adjustment procedure by the focus control unit 4 (Step S54) are conducted. Steps S51 through S54 are the same steps as Steps S1 through S4 described in Embodiment 1.

Next, after the completion of Step S54, the storage unit 2 outputs pickup data to the trimming unit 9. Then, in Embodiment 2, the trimming unit 9 conducts a trimming procedure (Step S55), which is different from Embodiment 1. Thereafter, the trimming unit 9 outputs the pickup data subjected to the trimming to the storage medium 7 (Step S56) so as to complete the photographing.

As stated above, according to the image pickup device and the image pickup method of Embodiment 2, a position of the photographer can be detected based on the emission position of the light beam emitted from the remote control device, and the trimming can be conducted based on this position. Therefore, without the need for the photographer to observe through the finder of the image pickup device and confirm his/her standing position beforehand with eye measurement, the photographing can be conducted so that the photographer can be arranged in the center of a frame or the vicinity of the center of the frame of the final pickup data. In addition, with the use of the image pickup device and the image pickup method according to Embodiment 2, the effects described in Embodiment 1 can be obtained as well.

Furthermore, the image pickup device according to Embodiment 2 may be provided with a moving mechanism that allows both of the optical system 5 and the image pickup element to move in a direction perpendicular to an optical axis of the optical system 5. Furthermore, in this case, the focus control unit 4 may make the moving mechanism move both of the optical system 5 and the image pickup element so that the position of the luminous point 13 detected by the detection unit 3 is located at the center of the trimming area 16 or close to the center of the trimming area 16.

Such an embodiment can avoid a case of frame-out of the photographer that cannot be dealt with the trimming procedure, e.g., a case where the trimming procedure is unable to make the whole of the photographer fall within the photographing area. Furthermore, a photographer carrying the remote control device can be followed automatically so as to be photographed.

Furthermore, similarly to Embodiment 1, programs embodying Steps S51 through S56 shown in FIG. 10 may be installed into a personal computer to which an external camera (a camera equipped with the optical system and the image pickup unit in Embodiment 1 only) is connected via USB and the like or into a computer to which a general digital camera is connected, and these programs may be executed, whereby the image pickup device according to Embodiment 2 can be realized.

Embodiment 3

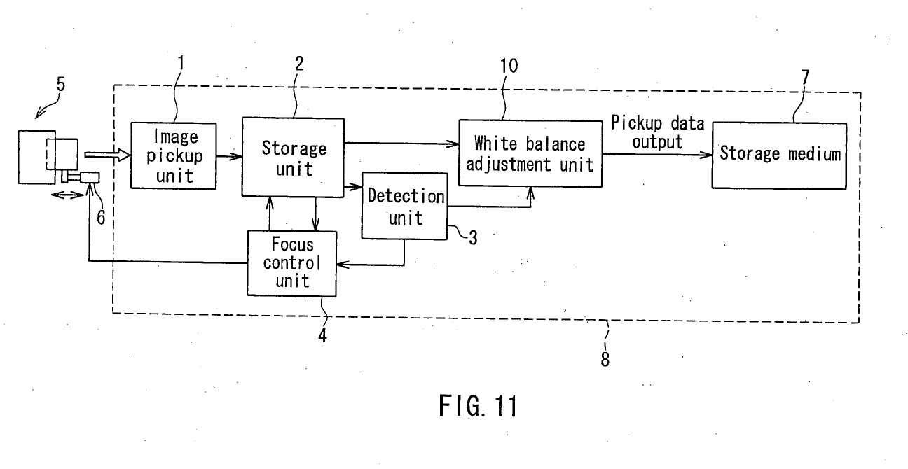

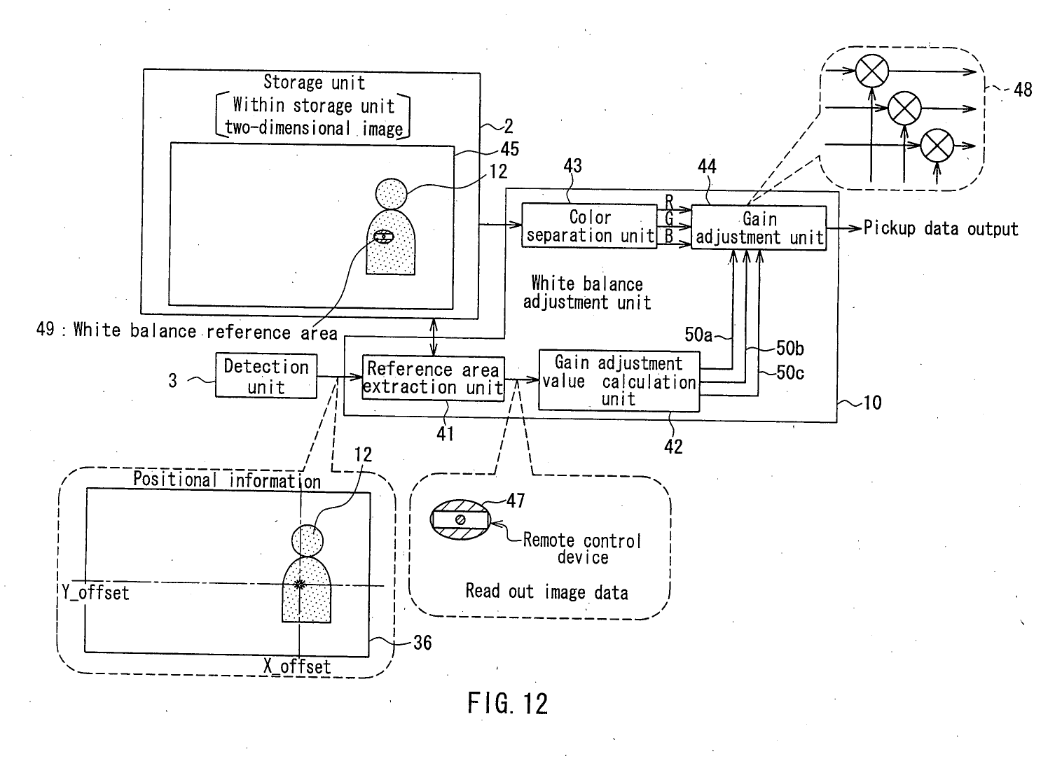

The following describes an image pickup device and an image pickup method according to Embodiment 3 of the present invention, with reference to FIGS. 11 to 14. Firstly, referring to FIGS. 11 and 12, a configuration of the image pickup device according to Embodiment 3 will be explained below. The image pickup device according to Embodiment 3 also is a digital still camera.

FIG. 11 shows a main configuration of the image pickup device according to Embodiment 3 of the present invention. FIG. 12 shows a configuration of a white balance adjustment unit shown in FIG. 11 more specifically.

As shown in FIG. 11, the image pickup device according to Embodiment 3 has the white balance adjustment unit 10, which is different from the image pickup device according to Embodiment 1. Except for this point, the image pickup device according to Embodiment 3 has the same configuration as that of the image pickup device according to Embodiment 1.

Furthermore, in Embodiment 3, a remote control device (not shown) has a case provided with a portion in a reference color, and the white balance adjustment unit 10 adjusts white balance with reference to the reference color of the case. Note here that although the reference color in Embodiment 3 is white, the present invention is not limited to white. Furthermore, the case as the whole may be in the reference color, or a part of this may be in the reference color. Furthermore, the white balance adjustment unit 10 is equipped with a white balance adjustment function also that is provided in the conventional digital camera.

Referring now to FIG. 12, a specific configuration of the white balance adjustment unit 10 will be explained below. As shown in FIG. 12, the white balance adjustment unit 10 has a reference area extraction unit 41, a gain adjustment value calculation unit 42, a color separation unit 43 and a gain adjustment unit 44. The reference area extraction unit 41 receives positional information 36 for specifying the coordinates (X_offset, Y_offset) from a detection unit 3. The reference area extraction unit 41 accesses the storage unit 2 so as to extract image data 47 of an area 49 (white balance reference area) including a white (reference color) area of the case of the remote control device from image data 45 stored in Bank(n) of the storage unit 2.

The gain adjustment value calculation unit 42, based on the extracted image data 47 of the white balance reference area 49, calculates a gain adjustment value for each component such as a R component, a G component and a B component, where the gain adjustment value is for adjusting a RGB ratio of an average color of the white balance reference area 49 to a preset ratio. The gain adjustment values 50a to 50c calculated for the respective components are output to the gain adjustment unit 44.

Note here that R:G:B in Embodiment 3 is set at 1:1:1. However, the RGB ratio in the present invention is not limited to this example, and a photographer can set this ratio freely.

The color separation unit 43 separates image data output from the storage unit 2 as pickup data into the R component, the G component and the B component, and inputs the respective components to the gain adjustment unit 44. The gain adjustment unit 44 conducts gain adjustment of at least one of the R component, the G component and the B component separated by the color separation unit 43, using the gain adjustment values calculated by the gain adjustment value calculation unit 42 (See conceptual diagram 48 in FIG. 12). After the gain adjustment, the color separation unit 43 synthesizes the R component, the G component and the B component and outputs the image data obtained by the synthesis to a storage medium 7 as pickup data.

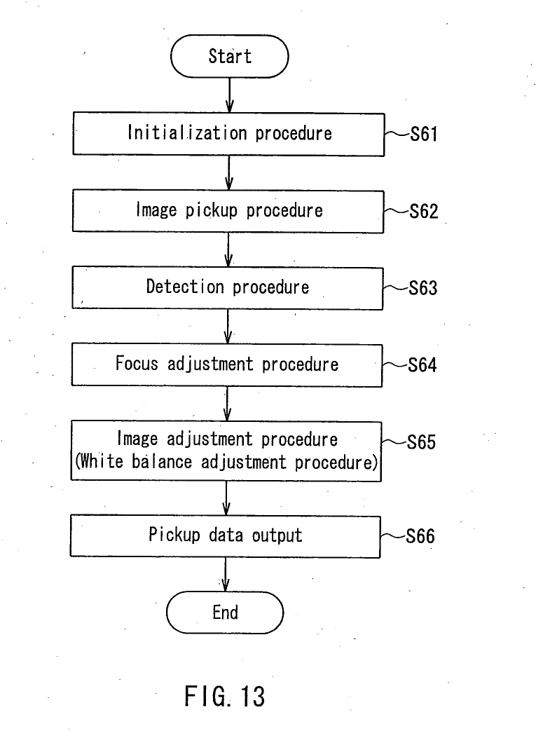

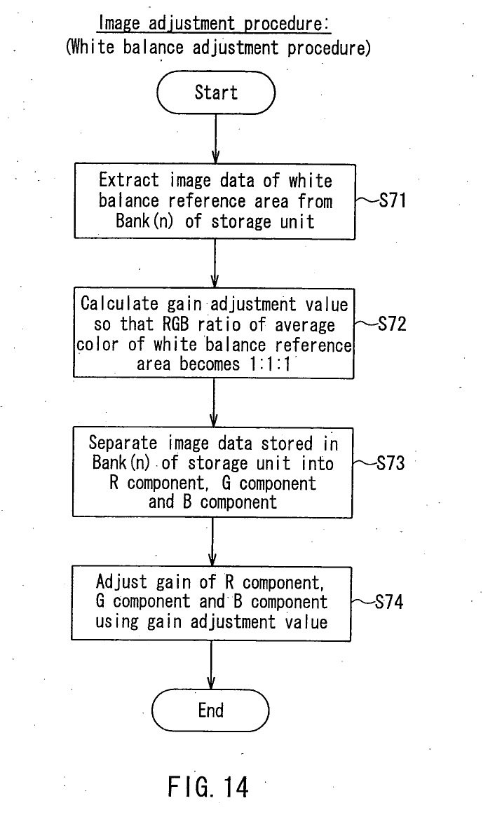

The following describes an image pickup method and operations of the image pickup device according to Embodiment 3, with reference to FIGS. 13 and 14. Similarly to Embodiment 1, the image pickup method according to Embodiment 3 is implemented by operating the image pickup device according to Embodiment 3. Thus, the image pickup method according to Embodiment 3 will be explained by explaining the operations of the image pickup device according to Embodiment 3.

FIG. 13 is a flowchart showing the image pickup method and the operations of the image pickup device according to Embodiment 3 of the present invention. FIG. 13 shows general steps only. FIG. 14 is a flowchart showing general steps of an image adjustment procedure.

As shown in FIG. 13, in Embodiment 3 also, an initialization procedure is conducted firstly (Step S61) like Embodiment 1. Subsequently, an image pickup procedure by the image pickup unit 1 and the storage unit 2 (Step S62); a detection procedure by the detection unit 3 (Step S63) and a focus adjustment procedure by the focus control unit 4 (Step S64) are conducted. Steps S61 through S64 are the same steps as Steps S1 through S4 described in Embodiment 1.

Next, after the completion of the focus adjustment procedure (Step S64), the storage unit 2 outputs pickup data to the white balance adjustment unit 10, and then the white balance adjustment unit 10 conducts the image adjustment procedure (white balance adjustment procedure) (Step S65), which is different from Embodiment 1. Thereafter, the white balance adjustment unit 10 outputs the pickup data whose white balance has been adjusted to the storage medium 7 (Step S66) so as to complete the photographing.

Referring now to FIG. 14, the white balance adjustment procedure will be explained below more specifically. If required, FIG. 12 will be referred to in the following description.

As shown in FIG. 14, firstly, the reference area extraction unit 41 receives positional information 36 for specifying coordinates (X_offset, Y_offset) of a luminous point 13 from the detection unit 3, and then accesses the storage unit 2 so as to read out image data 47 of a white balance reference area 49 including the coordinates (X_offset, Y_offset) as its center from the image data 45 stored in Bank(n) of the storage unit (Step S71). During this step, in order to avoid the influence of a brightness of the luminous point on the adjustment of the white balance, the image data in a not-illumination state is read out as the image data 47 in Embodiment 3. Furthermore, the reference area extraction unit 41 outputs the image data 47 to the gain adjustment unit 42.

Note here that a size of the white balance reference area 49 can be set suitably depending on a distance between the subject to be photographed and the image pickup device 8. For instance, one possible embodiment is such that the white balance reference area 49 is expanded with increasing proximity between the subject and the image pickup device 8.

Next, the gain adjustment value calculation unit 42, based on the input image data 47, calculates gain adjustment values 50a to 50c so as to allow a RGB ratio of an average color of the white balance reference area 49 to be set at 1:1:1 (Step S72). Furthermore, the gain adjustment value calculation unit 42 outputs the calculated gain adjustment values to the gain adjustment unit 44.

Next, the color separation unit 43 separates image data output from the storage unit 2 as pickup data into the R component, the G component and the B component, and inputs the respective components to the gain adjustment unit 44 (Step S73). Note here that Steps S72 and S73 may be conducted concurrently. Alternatively, after the execution of Step S73, Step S72 may be executed.

Subsequently, when receiving the R component, the G component and the B component from the color separation unit 43 and receiving the gain adjustment values from the gain adjustment value calculation unit 42, the gain adjustment unit 44 conducts gain adjustment of all or a part of the input R component, G component and B component, based on the input gain adjustment values 50a to 50c (Step S74). After the gain adjustment, the image data in which the R component, the G component and the B component are synthesized is output to the storage medium 7 as pickup data so as to complete the white balance adjustment procedure.

As stated above, according to the image pickup device and the image pickup method according to Embodiment 3, the adjustment of the white balance can be conducted with reference to a part in the reference color that is provided in the case of the remote control device. Therefore, an ideal white balance can be obtained easily. In addition, with the use of the image pickup device and the image pickup method according to Embodiment 3, the effects described in Embodiment 1 can be obtained as well.

Furthermore, similarly to Embodiment 1, programs embodying Steps S61 through S66 shown in FIG. 13 and Steps S71 to S74 shown in FIG. 14 may be installed into a personal computer to which an external camera (a camera equipped with the optical system and the image pickup unit in Embodiment 1 only) is connected via USB and the like or into a computer to which a general digital camera is connected, and these programs may be executed, whereby the image pickup device according to Embodiment 3 can be realized.

Embodiment 4

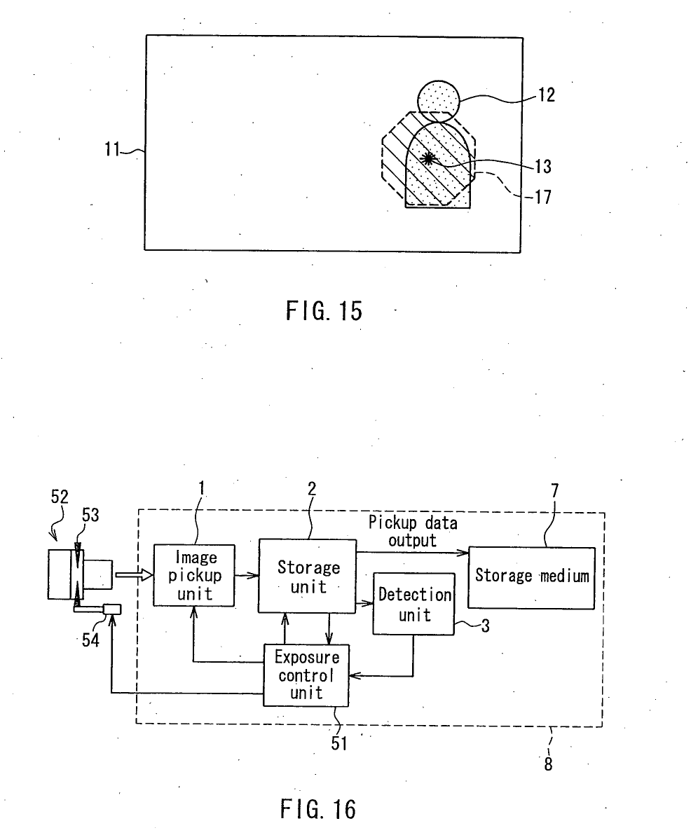

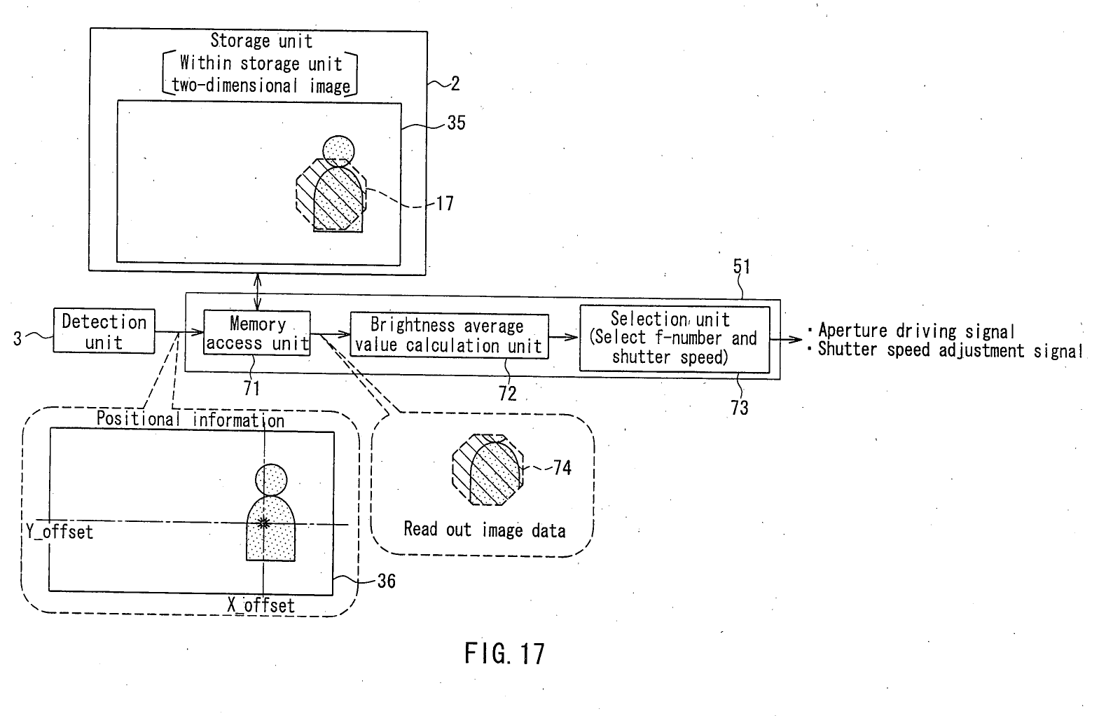

The following describes an image pickup device and an image pickup method according to Embodiment 4 of the present invention, with reference to FIGS. 15 to 19. Firstly, referring to FIGS. 15 and 17, a configuration of the image pickup device according to Embodiment 4 will be explained below. The image pickup device according to Embodiment 4 also is a digital still camera.

FIG. 15 shows an image seen in a finder of the image pickup device when a photographer takes his/her own photograph using the image pickup device according to Embodiment 4 of the present invention. FIG. 16 shows a general configuration of the image pickup device according to Embodiment 4 of the present invention. FIG. 17 shows a specific configuration of an exposure control unit shown in FIG. 16.

As shown in FIG. 15, when the photographer takes a photograph of himself/herself as a subject, the image pickup device according to Embodiment 4 has a function of detecting a position of a luminous point 13 of a light beam (emission position of the light beam) emitted from a remote control device, setting an area (photometry area) 17 as a target of exposure adjustment based on the detected emission position of the light beam and conducting the exposure adjustment with reference to a brightness of the thus set photometry area 17.

As shown in FIG. 16, in Embodiment 4 as in Embodiment 1, the image pickup device also is equipped with an image pickup unit 1, a storage unit 2, a detection unit 3 and an optical system 52. Therefore, in Embodiment 4 as in Embodiment 1, the luminous point 13 of the remote control device can be detected. A storage medium 7 also is provided so as to record pickup data.

However, in Embodiment 4, the image pickup device is equipped with the exposure control unit 51, which is different from Embodiment 1. The exposure control unit 51 sets the photometry area 17 (See FIG. 15) with reference to the emission position of the light beam, and conducts the exposure adjustment with reference to the brightness of the photometry area 17. Note here that the photometry area 17 is set by the exposure control unit 51 based on the positional information output from the detection unit 3, which is conducted in a similar manner to the setting of the focus detection area by the focus control unit described in Embodiment 1.

Furthermore, unlike Embodiment 1, the optical system 52 is equipped with an aperture 53 and an aperture adjustment mechanism 54 that changes a f-number. The optical system 52 has a configuration that enables a change of the f-number of the aperture 53 of the optical system 52 in response to an instruction from the exposure control unit 51.

Referring now to FIG. 17, a specific configuration of the exposure control unit 51 will be explained below. As shown in FIG. 17, the exposure control unit 51 has a memory access unit 71, a brightness average value calculation unit 72 and a selection unit 73. Similarly to the memory access unit shown in FIG. 6 in Embodiment 1, the memory access unit 71 receives positional information 36 for specifying coordinates (X_offset, Y_offset) of the luminous point from the detection unit 3.

Furthermore, similarly to the memory access unit shown in FIG. 6 in Embodiment 1, the memory access unit 71 accesses the storage unit 2 so as to read out image data 74 of a photometry area 17 including the coordinates (X_offset, Y_offset) as its center from the image data 35 stored in Bank(n) of the storage unit 2. During this step, in order to avoid the influence of a brightness of the luminous point on the calculation of an average brightness, the image data in a not-illumination state is read out as the image data 74 in Embodiment 4.

The brightness average value calculation unit 72 calculates an average brightness value of the photometry area from the image data 74. The average brightness is calculated by obtaining the total sum of brightness information of the pixel data within the photometry area 17 and dividing it by the number of pixels included in the photometry area.

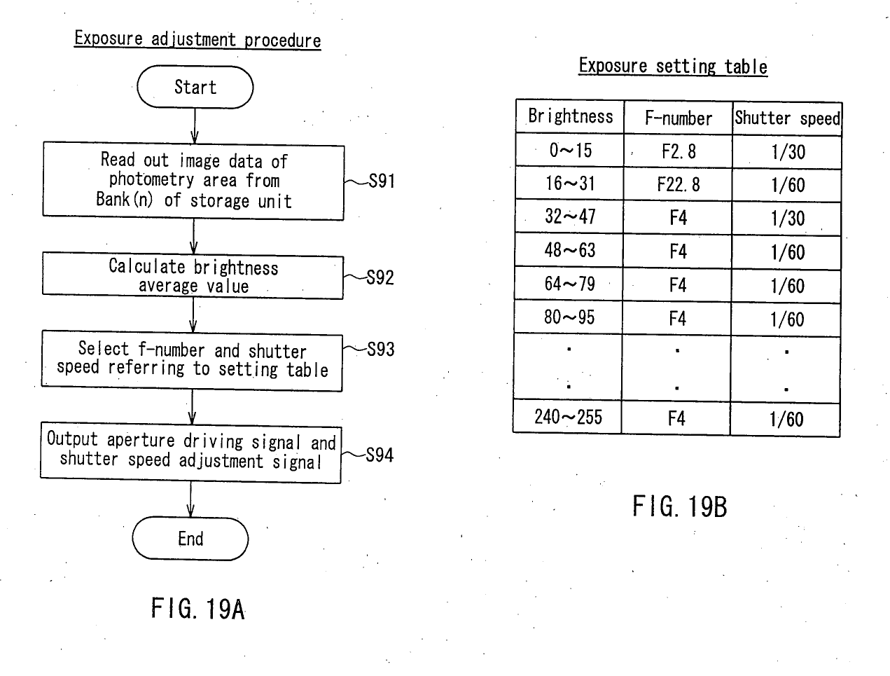

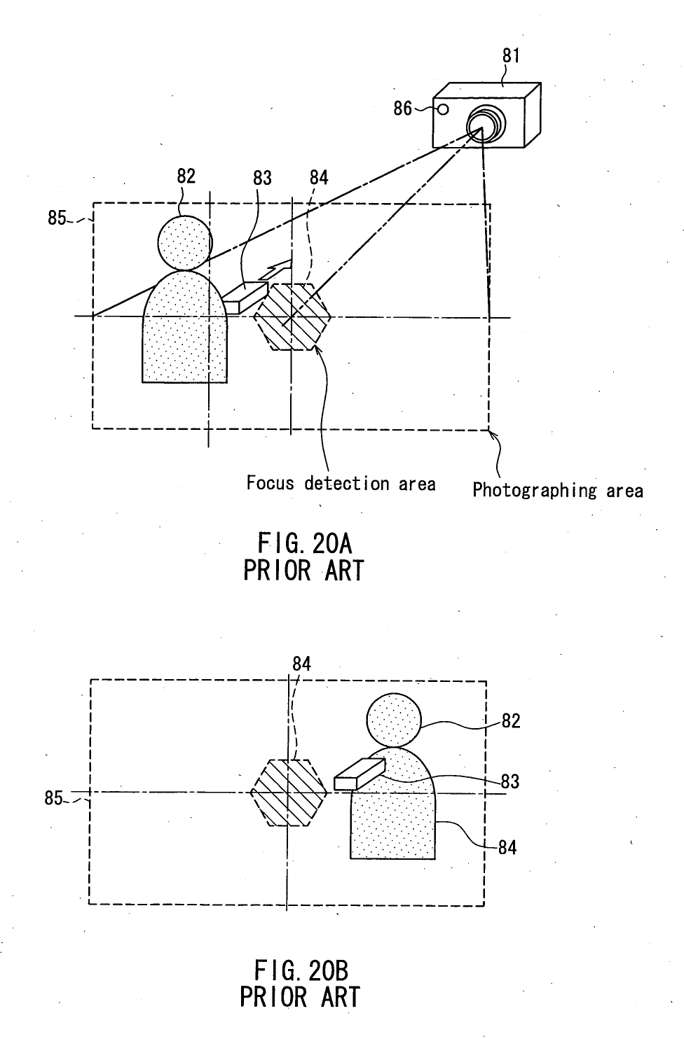

The selection unit 73 selects an optimum f-number and shutter speed based on the calculated brightness average value. The selection of the f-number and the shutter speed by the selection unit 73 is carried out by using an exposure setting table shown in FIG. 19B, which will be described later. The exposure setting table is stored in the storage unit 2.

Furthermore, when selecting the f-number and the shutter speed, the selection unit 73 outputs an aperture driving signal to the aperture adjustment mechanism 54 (See FIG. 16) and outputs a shutter speed adjustment signal to the image pickup unit 1 (See FIG. 16). When receiving the aperture driving signal, the aperture adjustment mechanism 54 drives the aperture 53 of the optical system 52 so that the aperture has the selected f-number. When receiving the shutter speed adjustment signal, the image pickup unit 1 changes a timing of the discharging pulse to be added to the image pickup element in accordance with the selected shutter speed.

In Embodiment 4, the aperture adjustment mechanism 54 is configured with a servo motor, a gear and the like. However, the present invention is not limited to this. The aperture adjustment mechanism 54 may be an ultrasonic motor, for example, that is capable of moving the aperture 53 without the help of a gear and the like. Furthermore, in an image pickup device that includes an optical system 52 removable from a main body of a camera, the aperture adjustment mechanism 54 may be mounted on the main body of the camera or may be mounted on the optical system 52.

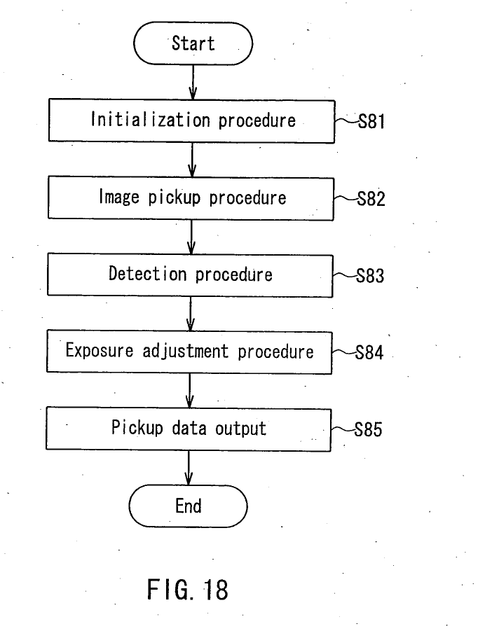

The following describes an image pickup method and operations of the image pickup device according to Embodiment 4, with reference to FIGS. 18 and 19. Note here that, like Embodiment 1, the image pickup method according to Embodiment 4 is implemented by operating the image pickup device according to Embodiment 4. Thus, the image pickup method according to Embodiment 4 also will be explained by explaining the operations of the image pickup device according to Embodiment 4.

FIG. 18 is a flowchart showing the image pickup method and the operations of the image pickup device according to Embodiment 4 of the present invention. FIG. 18 shows general steps only. FIG. 19 shows the exposure adjustment procedure, where FIG. 19A is a flowchart showing the major steps of the exposure adjustment procedure, and FIG. 19B shows the exposure setting table used in the exposure adjustment procedure.

As shown in FIG. 18, in Embodiment 4 also, an initialization procedure is conducted firstly (Step S81) like Embodiment 1. Subsequently, an image pickup procedure is conducted by the image pickup unit 1 and the storage unit 2 (Step S82) and a detection procedure is conducted by the detection unit 3 (Step S83). Note here that Steps S81 through S83 are the same steps as Steps S1 through S3 described in Embodiment 1. Furthermore, in Embodiment 4, the initialization procedure is conducted by the exposure control unit 51.

Next, the exposure control unit 51 conducts the exposure adjustment with reference to the brightness of the photometry area 17 (Step S84). Thereafter, the storage unit 2 outputs pickup data to the storage medium 7 (Step S85) so as to complete the photographing.

Referring now to FIG. 19, the exposure adjustment procedure will be explained more specifically. If required, FIG. 17 will be referred to in the following description.

As shown in FIG. 19A, firstly, when receiving the positional information 36 for specifying the coordinates (X_offset, Y_offset) from the detection unit 3, the memory access unit 71 firstly accesses the storage unit 2 to read out the image data 74 of the photometry area 17 including the coordinates (X_offset, Y_offset) as its center from the image data 35 stored in Bank(n) of the storage unit 2 (Step S91). Furthermore, the memory access unit 71 outputs the read out image data 74 to the brightness average value calculation unit 72.

Next, the brightness average value calculation unit 72 calculates an average brightness value of the photometry area from the image data 74, and inputs the calculated average brightness value to the selection unit 73 (Step S92). Subsequently, the selection unit 73 reads out the exposure setting table as shown in FIG. 19B from the storage unit 2, and applies the input brightness average value to the exposure setting table so as to select an optimum f-number and shutter speed (Step S93).

Thereafter, when the selection unit 73 outputs an aperture driving signal to the aperture adjustment mechanism 54 and outputs a shutter speed adjustment signal to the image pickup unit 1 (Step S94), the exposure adjustment procedure is completed.

Note here that although the exposure adjustment by the image pickup unit 1 that changes a shutter speed of an electronic shutter has been described with reference to FIGS. 15 to 19, a mechanical shutter may be provided in the optical system in Embodiment 4 and a shutter speed of this mechanical shutter mechanism may be changed so as to conduct the exposure adjustment. Alternatively, another possible embodiment includes both of the electronic shutter and the mechanical shutter mechanism, and shutter speeds of both may be changed so as to conduct the exposure adjustment.

As stated above, according to the image pickup device and the image pickup method of Embodiment 4, the exposure adjustment can be carried out by setting a periphery area of a position where the light beam is emitted from the remote control device at the photometry area. Thus, in the case where a photographer takes his/her own photograph, the photographer can obtain a photograph or an image with exposure adjustment appropriately conducted with respect to himself/herself as the subject simply by staying in the photographing area and operating the remote control device.

Furthermore, similarly to Embodiment 1, programs embodying Steps S81 through S85 shown in FIG. 18 and Steps S91 to S94 shown in FIG. 19A may be installed into a personal computer to which an external camera (a camera equipped with the optical system and the image pickup unit in Embodiment 1 only) is connected via USB and the like or into a computer to which a general digital camera is connected, and these programs may be executed, whereby the image pickup device according to Embodiment 4 can be realized.

Moreover, the image pickup device according to Embodiment 4 may be provided with one of the trimming unit shown in Embodiment 2 and the white balance adjustment unit shown in Embodiment 3 or both of them.

The image pickup device and the image pickup method of the present invention are not limited to the above-described Embodiments 1 to 4. For instance, the image pickup device of the present invention may be provided with both of the focus control unit shown in Embodiment 1 and the exposure control unit shown in Embodiment 4 so as to enable the focus adjustment procedure and the exposure adjustment procedure. In addition, this embodiment further may be provided with one of the trimming unit shown in Embodiment 2 and the white balance adjustment unit shown in Embodiment 3 or both of them.

Furthermore, the remote control device used in the present invention may be one that emits visible light or other light such as infrared light. The remote control device may be any one as long as it can emit signals detectable by the image pickup element. Furthermore, the light emitted from the remote control device may not change in a preset pattern, for example, a light beam in a certain color may be emitted from the remote control device and the detection unit may be configured to be capable of detecting this light beam in the certain color.

Furthermore, in the above-stated Embodiments 1 through 4, examples where the various areas are set around the positional coordinates of the luminous point (X_offset, Y_offset) were described. However, the present invention is not limited to the examples having the coordinates as their center, as long as a relative positional relationship is determined between the light beam and the areas.

Moreover, in the above-stated Embodiments 1 to 4, examples where the image pickup device of the present invention is a digital still camera were described. However, the image pickup device of the present invention may be a digital video camera.

As stated above, according to the image pickup devices and the image pickup methods of the present invention, when a photographer takes his/her own photograph, a favorable image can be obtained.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. An image pickup device, comprising:
an image pickup unit that converts an image projected by an optical system into image data and outputs the image data;
a storage unit that stores the image data output from the image pickup unit;
a detection unit that detects an emission position of a signal emitted from an external device from the image data stored in the storage unit; and
a focus control unit that sets an area as a target of focus adjustment based on the detected emission position of the signal and adjusts a focus of the optical system so as to maximize a frequency component within a preset frequency band of image data of the area as the target of the focus adjustment.

2. The image pickup device according to claim 1,
wherein the external device is configured to be capable of emitting a light beam in a preset pattern as the signal,
the image pickup unit comprises an image pickup element that converts an image projected by the optical system into image data at a preset time interval, each piece of the image data converted by the image pickup element being output sequentially per each frame to the storage unit,
the storage unit stores therein each piece of image data output from the image pickup unit in the output order, and
the detection unit makes a comparison among the respective pieces of image data stored in the storage unit so as to detect a pixel or a group of pixels that are changed in the preset pattern and regards a position of the detected pixel or group of pixels as the emission position.

3. The image pickup device according to claim 1, further comprising a trimming unit that cuts an image displayed in accordance with the image data stored in the storage unit to be in a preset size,
wherein the trimming unit conducts the cutting so that the emission position of the signal detected by the detection unit is located at the center of the cut image or becomes close to the center of the cut image.

4. The image pickup device according to claim 3,
wherein the image pickup unit comprises an image pickup element,
the image pickup device further comprises a moving mechanism that moves both of the optical system and the image pickup element in a direction perpendicular to an optical axis of the optical system, and
the focus control unit makes the moving mechanism move both of the optical system and the image pickup element so that the emission position of the signal detected by the detection unit is located at the center of the cut image or becomes close to the center of the cut image.

5. The image pickup device according to claim 1, further comprising an exposure control unit that sets an area as an object of exposure adjustment based on the emission position of the signal, and conducts the exposure adjustment with reference to brightness of the area as the target of the exposure adjustment.

6. The image pickup device according to claim 5,
wherein the optical system comprises an aperture whose f-number is variable, and the image pickup unit comprises an electronic shutter whose shutter speed is variable, and
the exposure control unit calculates an average brightness value of the area as the target of the exposure adjustment, and adjusts at least one of the f-number and the shutter speed based on the calculated average brightness value.

7. The image pickup device according to claim 5,
wherein the optical system comprises an aperture whose f-number is variable and a shutter mechanism whose shutter speed is variable, and
the exposure control unit calculates an average brightness value of the area as the target of the exposure adjustment, and adjusts at least one of the f-number and the shutter speed based on the calculated average brightness value.

8. The image pickup device according to claim 1, wherein the external device is a remote control device for conducting remote control of the image pickup device.

9. The image pickup device according to claim 8,
wherein the remote control device comprises a case provided with a portion in a preset reference color, and
the image pickup device comprises a white balance adjustment unit that conducts adjustment of white balance with reference to the reference color.

10. The image pickup device according to claim 9,
wherein the white balance adjustment unit comprises:
a reference area extraction unit that extracts image data of an area including the portion in the reference color from the image data stored in the storage unit;
a gain adjustment value calculation unit that calculates a gain adjustment value based on the extracted image data of the area including the portion in the reference color, the gain adjustment value being for making a RGB ratio of an average color of the area including the portion in the reference color a preset ratio;
a color separation unit that separates the image data stored in the storage unit into a R component, a G component and a B component; and
a gain adjustment unit that conducts gain adjustment of at least one of the R component, the G component and the B component using the calculated gain adjustment value.

11. An image pickup device, comprising:
an image pickup unit that converts an image projected by an optical system into image data and outputs the image data;
a storage unit that stores the image data output from the image pickup unit;
a detection unit that detects an emission position of a signal emitted from an external device from the image data stored in the storage unit; and
an exposure control unit that sets an area as a target of exposure adjustment based on the detected emission position of the signal and conducts the exposure adjustment with reference to brightness of the area as the target of the exposure adjustment.

12. The image pickup device according to claim 11,
wherein the external device is configured to be capable of emitting a light beam in a preset pattern as the signal,
the image pickup unit comprises an image pickup element that converts an image projected by the optical system into image data at a preset time interval, each piece of the image data converted by the image pickup element being output sequentially per each frame to the storage unit,
the storage unit stores therein each piece of image data output from the image pickup unit in the output order, and
the detection unit makes a comparison among the respective pieces of image data stored in the storage unit so as to detect a pixel or a group of pixels that are changed in the preset pattern and regards the detected pixel or group of pixels as the emission position.

13. The image pickup device according to claim 11,
wherein the optical system comprises an aperture whose f-number is variable, and the image pickup unit comprises an electronic shutter whose shutter speed is variable, and
the exposure control unit calculates an average brightness value of the area as the target of the exposure adjustment, and adjusts at least one of the f-number and the shutter speed based on the calculated average brightness value.

14. The image pickup device according to claim 11,
wherein the optical system comprises an aperture whose f-number is variable and a shutter mechanism whose shutter speed is variable, and
the exposure control unit calculates an average brightness value of the area as the target of the exposure adjustment, and adjusts at least one of the f-number and the shutter speed based on the calculated average brightness value.

15. The image pickup device according to claim 11, further comprising a trimming unit that cuts an image displayed in accordance with the image data stored in the storage unit to be in a preset size,
wherein the trimming unit conducts the cutting so that the emission position of the signal detected by the detection unit is located at the center of the cut image or becomes close to the center of the cut image.

16. The image pickup device according to claim 15,
wherein the image pickup unit comprises an image pickup element,
the image pickup device further comprises a moving mechanism that moves both of the optical system and the image pickup element in a direction perpendicular to an optical axis of the optical system, and
the focus control unit makes the moving mechanism move both of the optical system and the image pickup element so that the emission position of the signal detected by the detection unit is located at the center of the cut image or becomes close to the center of the cut image.

17. The image pickup device according to claim 11, wherein the external device is a remote control device for conducting remote control of the image pickup device.

18. The image pickup device according to claim 17,
wherein the remote control device comprises a case provided with a portion in a preset reference color, and
the image pickup device comprises a white balance adjustment unit that conducts adjustment of white balance with reference to the reference color.

19. The image pickup device according to claim 18,
wherein the white balance adjustment unit comprises:
a reference area extraction unit that extracts image data of an area including the portion in the reference color from the image data stored in the storage unit;
a gain adjustment value calculation unit that calculates a gain adjustment value based on the extracted image data of the area including the portion in the reference color, the gain adjustment value being for making a RGB ratio of an average color of the area including the portion in the reference color a preset ratio;
a color separation unit that separates the image data stored in the storage unit into a R component, a G component and a B component; and
a gain adjustment unit that conducts gain adjustment of at least one of the R component, the G component and the B component using the calculated gain adjustment value.

20. An image pickup device, comprising:
a remote control device that is configured to be capable of emitting a signal;
an image pickup unit that converts an image projected by an optical system into image data and outputs the image data;
a storage unit that stores the image data output from the image pickup unit;
a detection unit that detects an emission position of the signal emitted from the remote control device from the image data stored in the storage unit; and
a focus control unit that sets an area as a target of focus adjustment based on the detected emission position of the signal and adjusts a focus of the optical system so as to maximize a frequency component within a preset frequency band of image data of the area as the target of the focus adjustment.

21. An image pickup device, comprising:
a remote control device that is configured to be capable of emitting a signal;
an image pickup unit that converts an image projected by an optical system into image data and outputs the image data;
a storage unit that stores the image data output from the image pickup unit;
a detection unit that detects an emission position of the signal emitted from the remote control device from the image data stored in the storage unit; and
an exposure control unit that sets an area as a target of exposure adjustment based on the detected emission position of the signal and conducts the exposure adjustment with reference to brightness of the area as the target of the exposure adjustment.

22. An image pickup method using an image pickup element that converts an image projected by an optical system into image data, comprising the steps of:
(a) outputting the image data converted by the image pickup element;
(b) storing the output image data into a storage device;
(c) detecting an emission position of a signal emitted from an external device from the image data stored in the storage device; and
(d) setting an area as a target of focus adjustment based on the detected emission position of the signal and adjusting a focus of the optical system so as to maximize a frequency component within a preset frequency band of image data of the area as the target of the focus adjustment.

23. The image pickup method according to claim 22, wherein the external device emits a light beam as the signal.

24. The image pickup method according to claim 22, further comprising the step of: cutting an image displayed in accordance with the image data stored in the storage unit to be in a preset size,
wherein the cutting is conducted so that the emission position of the signal detected in the step (c) is located at the center of the cut image or becomes close to the center of the cut image.

25. The image pickup method according to claim 22, further comprising the step of: setting an area as an object of exposure adjustment based on the detected emission position of the signal, and conducting the exposure adjustment with reference to brightness of the area as the target of the exposure adjustment.

26. The image pickup method according to claim 22,
wherein the external device comprises a case provided with a portion in a preset reference color, and
the image pickup method further comprises the step of conducting adjustment of white balance with reference to the reference color.

27. The image pickup method according to claim 26,
wherein the step of conducting the adjustment of white balance comprises the steps of:
extracting image data of an area including the portion in the reference color from the image data stored in the storage unit;
calculating a gain adjustment value based on the extracted image data of the area including the portion in the reference color, the gain adjustment value being for making a RGB ratio of an average color of the area including the portion in the reference color a preset ratio;
separating the image data stored in the storage unit into a R component, a G component and a B component; and
conducting gain adjustment of at least one of the R component, the G component and the B component using the calculated gain adjustment value.

28. An image pickup method using an image pickup element that converts an image projected by an optical system into image data, comprising the steps of:
(a) outputting the image data converted by the image pickup element;
(b) storing the output image data into a storage device;
(c) detecting an emission position of a signal emitted from an external device from the image data stored in the storage device; and
(d) setting an area as a target of exposure adjustment based on the detected emission position of the signal and conducting the exposure adjustment with reference to brightness of the area as the target of the exposure adjustment.

29. The image pickup method according to claim 28, wherein the external device emits a light beam as the signal.

30. The image pickup method according to claim 28, further comprising the step of: cutting an image displayed in accordance with the image data stored in the storage unit to be in a preset size,
wherein the cutting is conducted so that the emission position of the signal detected in the step (c) is located at the center of the cut image or becomes close to the center of the cut image.

31. The image pickup method according to claim 28,
wherein the external device comprises a case provided with a portion in a preset reference color, and
the image pickup method further comprises the step of conducting adjustment of white balance with reference to the reference color.

32. The image pickup method according to claim 31,
wherein the step of conducting the adjustment of white balance comprises the steps of:
extracting image data of an area including the portion in the reference color from the image data stored in the storage unit;
calculating a gain adjustment value based on the extracted image data of the area including the portion in the reference color, the gain adjustment value being for making a RGB ratio of an average color of the area including the portion in the reference color a preset ratio;
separating the image data stored in the storage unit into a R component, a G component and a B component; and
conducting gain adjustment of at least one of the R component, the G component and the B component using the calculated gain adjustment value.

33. A computer program product comprising a program recorded in a recording medium, the program making a computer execute image pickup using an image pickup element that converts an image projected by an optical system into image data, wherein the program recorded in the recording medium contains commands that make the computer execute the steps of:
(a) outputting the image data converted by the image pickup element;
(b) storing the output image data into a storage device;
(c) detecting an emission position of a signal emitted from an external device from the image data stored in the storage device; and
(d) setting an area as a target of focus adjustment based on the detected emission position of the signal and adjusting a focus of the optical system so as to maximize a frequency component within a preset frequency band of image data of the area as the target of the focus adjustment.

34. The computer program product according to claim 33, wherein the external device emits a light beam as the signal.

35. The computer program product according to claim 33,
wherein the program further contains a command that makes the computer execute the step of cutting an image displayed in accordance with the image data stored in the storage unit to be in a preset size,
wherein the cutting is conducted so that the emission position of the signal detected in the step (c) is located at the center of the cut image or becomes close to the center of the cut image.

36. The computer program product according to claim 33,
wherein the program further contains a command that makes the computer execute the step of setting an area as an object of exposure adjustment based on the detected emission position of the signal, and conducting the exposure adjustment with reference to brightness of the area as the target of the exposure adjustment.

37. The computer program product according to claim 33,
wherein the external device comprises a case provided with a portion in a preset reference color, and
the program further contains a command that makes the computer execute the step of conducting adjustment of white balance with reference to the reference color.

38. The computer program product according to claim 37,
wherein the step of conducting the adjustment of white balance comprises the steps of:
extracting image data of an area including the portion in the reference color from the image data stored in the storage unit;
calculating a gain adjustment value based on the extracted image data of the area including the portion in the reference color, the gain adjustment value being for making a RGB ratio of an average color of the area including the portion in the reference color a preset ratio;
separating the image data stored in the storage unit into a R component, a G component and a B component; and
conducting gain adjustment of at least one of the R component, the G component and the B component using the calculated gain adjustment value.

39. A computer program product comprising a program recorded in a recording medium, the program making a computer execute image pickup using an image pickup element that converts an image projected by an optical system into image data, wherein the program recorded in the recording medium contains commands that make the computer execute the steps of:
(a) outputting the image data converted by the image pickup element;
(b) storing the output image data into a storage device;
(c) detecting an emission position of a signal emitted from an external device from the image data stored in the storage device; and
(d) setting an area as a target of exposure adjustment based on the detected emission position of the signal and conducting the exposure adjustment with reference to brightness of the area as the target of the exposure adjustment.

40. The computer program product according to claim 39, wherein the external device emits a light beams as the signal.

41. The computer program product according to claim 39,
wherein the program further contains a command that makes the computer execute the step of cutting an image displayed in accordance with the image data stored in the storage unit to be in a preset size,
wherein the cutting is conducted so that the emission position of the signal detected in the step (c) is located at the center of the cut image or becomes close to the center of the cut image.

42. The computer program product according to claim 39,
wherein the external device comprises a case provided with a portion in a preset reference color, and
the program further contains a command that makes the computer execute the step of conducting adjustment of white balance with reference to the reference color.

43. The computer program product according to claim 42,
wherein the step of conducting the adjustment of white balance comprises the steps of:
extracting image data of an area including the portion in the reference color from the image data stored in the storage unit;
calculating a gain adjustment value based on the extracted image data of the area including the portion in the reference color, the gain adjustment value being for making a RGB ratio of an average color of the area including the portion in the reference color a preset ratio;
separating the image data stored in the storage unit into a R component, a G component and a B component; and
conducting gain adjustment of at least one of the R component, the G component and the B component using the calculated gain adjustment value.
